(19) United States
(12) Patent Application Publication
(10) Pub. No.: US 2023/0334360 A1
(43) Pub. Date: Oct. 19, 2023

(54) MODEL-INDEPENDENT FEATURE SELECTION

(71) Applicant: KOCH BUSINESS SOLUTIONS, LP, Wichita, KS (US)

(72) Inventors: Maxim KORMILITSIN, Dallas, TX (US); Nathan R. HAMILTON, Wichita, KS (US); Yeonjoo JUNG, Wichita, KS (US)

(73) Assignee: KOCH BUSINESS SOLUTIONS, LP, Wichita, KS (US)

(21) Appl. No.: 17/785,409

(22) PCT Filed: May 14, 2021
(86) PCT No.: PCT/IB2021/054134

§ 371 Date: Jun. 15, 2022

Related U.S. Application Data
(60) Provisional application No. 63/025,641, filed on May 15, 2020.

(51) Int. Cl. G06N 20/00

(52) U.S. Cl. CPC G06N 20/00

(57) ABSTRACT

Systems and methods implement a Swiss tournament to determine which of a plurality of candidate feature variables provide the best predictive ability for a target variable. The Swiss tournament is advantageous when there are so many candidate feature variables that it is computationally infeasible to test all combinations of these candidates. Each candidate feature has an aggregate score that identifies how well it contributes to a model's prediction accuracy. With each iteration, or “round” of the Swiss tournament, the candidates are ranked and divided into subsets. All of the candidates within each subset are then used to train the model. Model-independent permutation techniques determine each candidate's contribution to the model's predictive accuracy, from which each candidate's score is then updated. Low-performing candidates may be removed from consideration, thereby speeding up subsequent iterations. At the end of the Swiss tournament, the highest-ranked candidates are the most-relevant for constructing a predictor.

### RELATED APPLICATIONS

This application claims priority to U.S. Provisional Patent Application No. 63/025,641, filed May 15, 2020, the entirety of which is incorporated herein by reference.

### BACKGROUND

Feature selection refers to methods and techniques for identifying the most relevant features, or input variables, inputted to a machine-learning or statistical prediction model. The “relevance” of a feature quantifies how much the feature contributes to the model's ability to generate accurate predictions. By contrast, a variable is termed “irrelevant” when it has little, if any, contribution to the model's predictive abilities. Irrelevant variables may be excluded from the model with negligible impact on the model's accuracy while advantageously simplifying and speeding up execution of the model. Furthermore, some features may be highly correlated or strongly iterating. Since these correlated variables are all not needed by the model, such features are termed “redundant”. Accordingly, the goal of feature selection is to identify the most relevant features while excluding irrelevant and redundant features.

### SUMMARY

Feature ranking is one approach to feature selection in which contributions of candidate features to the predictive accuracy of a target variable are individually determined and ranked. Most feature ranking is implemented using a “filter” that determines individual feature contributions without the use of any specific predictive model. For example, the filter may calculate a correlation coefficient or mutual information between each feature and the target variable. Filter-based feature ranking is fast since no model training is necessary, and widely applicable since it is model-agnostic. However, it ignores correlations between the candidate features, and therefore leads to rankings in which correlated features rank similarly even though they collectively provide little additional information over just one of them. Accordingly, the highest-ranked features are not necessarily the most relevant, or valuable, for constructing predictive models.

Other approaches to feature selection search a “subset space” of subsets of the candidate features to find subsets that optimize the predictive accuracy of a multivariable predictive model. In some of these approaches, a “wrapper” is used to score the performance of each subset as a whole (as opposed to scoring each feature individually) by training and running a predictive model with the subset. Since wrapper-based feature selection uses a predictive model, it can account for correlations between variables, even if the predictive model requires additional computational resources to implement. One drawback to wrappers is that the size of the subset space may be so large that an exhaustive search is unfeasible. Accordingly, search strategies like greedy hill climbing, particle swarm optimization, genetic algorithms, and simulated annealing have been used so that the search quickly converges to an optimum subset.

While feature selection is straightforward in concept, it can be challenging to select meaningful predictive data from a large real-world data set such that it is often either not feasible or so computationally demanding as to become infeasible due to costs. In addition, changes may cause features that were originally highly predictive to lose their advantage as other features become more predictive. As a result, certain individuals would appreciate further improvements in the ability to select features that have a meaningful predictive ability.

The present embodiments include systems and methods that rank a set of candidate features to identify those that are most valuable for constructing a predictor or model. The embodiments are inspired by the Swiss-tournament system that ranks participants in a tournament based on aggregate points. A Swiss tournament is used when there are too many participants to implement a round-robin tournament in which every participant faces every other participant. A Swiss tournament also tends to give better results than a single-elimination, or knockout, tournament in which top participants may be prematurely eliminated (e.g., when top participants face each other early in the tournament).

In the present embodiments, each candidate feature may be considered a participant with a corresponding aggregate score. In each iteration, or “round”, the candidate features are partitioned into subsets, each of which is used to train a prediction model and quantify each feature's contribution to the model's accuracy. The contributions are added to the candidate features' aggregate scores, after which the candidate features are re-ranked Rounds may continue until the ranking has converged. Like the wrapper-based feature selection described above, the use of a multivariable prediction model accounts for correlations between candidate features, helping to ensure that top-ranked features are orthogonal (i.e., highly correlated candidate features are not ranked similarly) and therefore optimal for constructing a prediction model. Since all of the candidate features participate in each round, each feature has the opportunity to “compete” against others and therefore be considered. At the end of the “tournament”, the highest-scoring candidate features can be used to create a prediction model with low redundancy.

The present embodiments may be used to both speed-up the construction of prediction models and increase their accuracy by preventing redundant and irrelevant features from being selected for inclusion. For some prediction models, up to one million candidate features, or more, may be considered, even though only a few may be valuable and included in the final model. Reducing the number of variables not only reduces the computational resources needed to run the final model, but it can also improve the model's accuracy since irrelevant features only add noise to the model. The removal of irrelevant and redundant features can also prevent overfitting.

Time-forecasting (i.e., predicting a future value for a time-series of a target variable) is one application that may benefit from the present embodiments. Here, the accuracy of the predicted future value may benefit by including time-series data from additional candidate features. A variety of algorithms exist on this spectrum of value prediction, ranging from statistical to machine learning and deep learning and/or neural network approaches. Examples include multivariate regression-based methods such as vector autoregression (VAR), machine-learning approaches such as long short-term memory (LSTM), and other types of multivariate forecasting.

Another example of where the present embodiments may be beneficial is supply-chain demand forecasting, a critical business function that provides directional guidance to a business about the amount and type of product that should be produced for a given customer or location. Univariate statistical methods that only rely on historic sales or production data of a product will be limited by the extent that history repeats itself. Conversely, multivariate algorithms allow for factors (i.e., features) that impact demand to be included in the model and typically provide greater accuracy. Examples of such factors include unemployment rate, consumer confidence, commodity and futures pricing, and other factors that contribute to underlying demand. The process of determining which factor or factors will increase predictive accuracy added to a multivariate predication model is time consuming and typically done through manual analysis. As a result, only a small number of external features typically informed by discussions with subject-matter experts are evaluated to determine their potential to increase accuracy.

The present embodiments advantageously save time for analysts and subject-matter experts by automating feature selection involving hundreds of thousands of candidate features, or more. In addition to accelerated time-to-value by completing projects faster, prediction accuracy is improved through the increased volume of features considered and the quality of the most valuably ranked features. Also, the ability to evaluate a large volume of features can lead to the discovery of economic and business factors impacting demand that are insightful and new knowledge that subject-matter experts and decision makers might find valuable in improving their understanding of the business. Further, the present embodiments allow for identification of features that might be missed by a human operator, such as when the candidate features number in the hundreds of thousands, or more. Additionally, once a model is moved to production, the automated review of enrichment data helps the model stay performant over time, and saves significant time required to continue evaluating new features. As a result, supply-chain demand forecasts stay more accurate.

The present embodiments could be used for other types of problems requiring the evaluation and ranking of relationships between features and one or more target variables. Examples include, but are not limited to, price elasticity factor selection, selecting factors for models that provide insight for profitable trading of futures or commodities, and evaluating factors contributing to issues in operational systems.

The present embodiments may also be used to improve the quality of dimensionality reduction, i.e., reducing a high-dimensional data set into a lower-dimensional data set in a computationally efficient manner that also requires discernment about uniqueness and orthogonality. Examples of this include, but are not limited to, image or lidar processing for automated driving or safety systems.

### BRIEF DESCRIPTION OF THE FIGURES

FIG. 1 shows a set of candidate features forming a candidate-feature ranking 106.

FIG. 2 illustrates a method for updating scores of features of a first bucket, in an embodiment.

FIG. 3 illustrates a method for sorting the features based on the updated scores, in an embodiment.

FIG. 4 is a flow chart of a feature-selection method, in embodiments.

FIG. 5 is a flow chart of a feature-selection method, in embodiments.

FIG. 6 illustrates a random partitioning method that may be used with the method of FIG. 5 to increase the likelihood that the method of FIG. 5 converges to a global optimum instead of a local optimum, in an embodiment.

FIG. 7 shows test data associated with each of the candidate features in a first bucket being inputted to a trained prediction model to obtain a first performance measure, in an embodiment.

FIG. 8 shows test data and target data being inputted to the trained prediction model of FIG. 7 to obtain a second performance measure that quantifies the performance of the prediction model in the absence of a first candidate feature, in an embodiment.

FIG. 9 is a flow chart of a method for constructing a multivariate prediction model, in embodiments.

FIG. 10 illustrates how the method of FIG. 4 may be used to generate single-target rankings and final candidate scores for the method of FIG. 9, in embodiments.

FIG. 11 shows a feature-score matrix storing final candidate scores, in an embodiment.

FIG. 12 illustrates how training data may be generated for the method of FIG. 9, in an embodiment.

FIG. 13 is a functional diagram of a feature-selection system that implements the present method embodiments, in embodiments.

FIG. 14 is a functional diagram of a big-data system that expands the feature-selection system of FIG. 13 to operate with a data repository, in embodiments.

### DETAILED DESCRIPTION

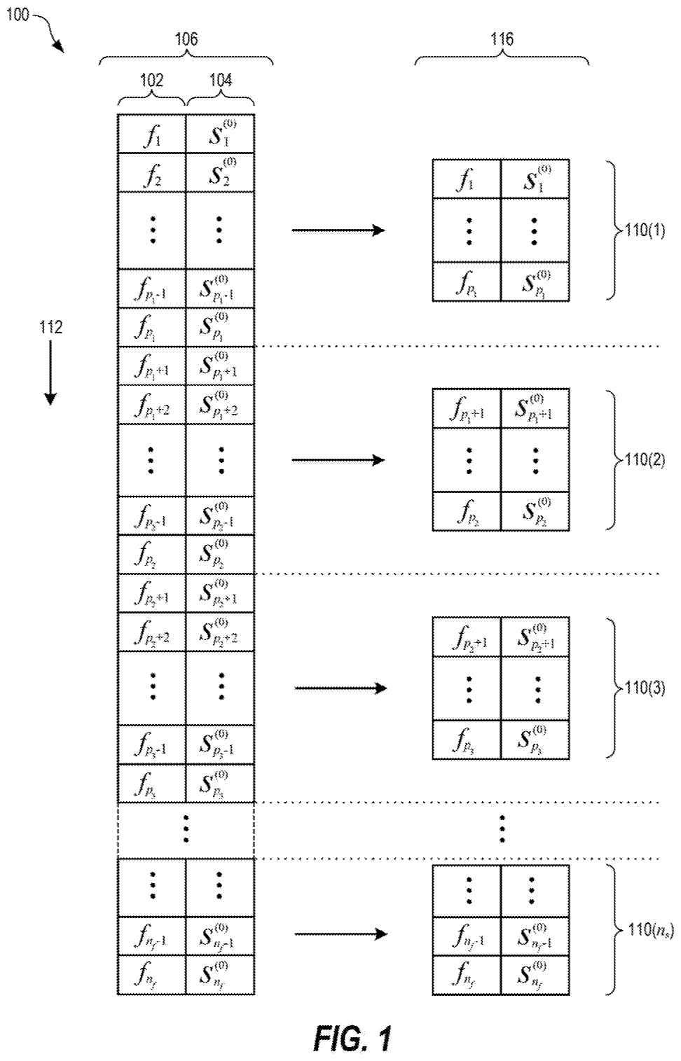

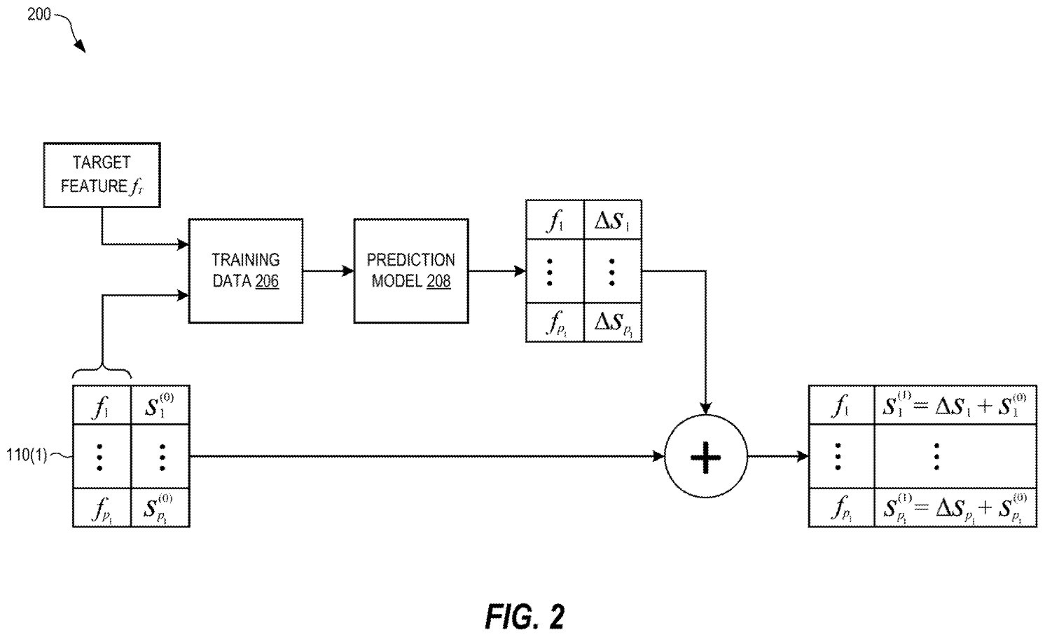

FIG. 1 shows a set of candidate features 102 forming a candidate-feature ranking 106. Each of the candidate features 102 is uniquely identified with a subscript between 1 and n_{f}, where n_{f} is the number of candidate features 102. Accordingly, the candidate features 102 are labeled f₁, f₂, . . . , fₙ_{_{f}}. Each candidate feature fᵢ has a corresponding score sᵢ⁽⁰⁾ (where 1≤i≤n_{f}) that quantifies the relevance, or predictive ability, of the candidate feature fᵢ with regards to a prediction model (e.g., see prediction model 208 in FIG. 2). In the candidate-feature ranking 106, the candidate features 102 are sorted in descending order 112 of the scores 104. A first score s₁⁽⁰⁾ is greater than or equal to a second score s₂⁽⁰⁾, which is greater than or equal to a third score s₃⁽⁰⁾, and so on. The first candidate feature f₁ has the highest score s₁⁽⁰⁾ and therefore may be referred to as the most-relevant candidate feature. Similarly, the second candidate feature f₂ has the second highest score s₂⁽⁰⁾ and therefore may be referred to as the second most-relevant candidate feature. The last candidate feature fₙ_{_{f}} has the lowest score sₙ_{_{f}}⁽⁰⁾ and may therefore be referred to as the least-relevant candidate feature. A superscript of each score sᵢ denotes an iteration, as described in more detail below. For clarity, the candidate features 102 may be simply referred to as “features”, and therefore each candidate feature fᵢ may be simply referred to as a “feature”.

Each of the n_{f} features 102 identifies one independent variable of a multivariable data set. For example, the data set may be a matrix of values, where each row of the matrix corresponds to one sample and each column of the matrix corresponds to one variable (i.e., one of the features 102). Thus, associated with each feature fᵢ are data values (i.e., feature data) stored in one corresponding column of the matrix. Furthermore, one of the columns of the matrix may store data values (i.e., target data or supervisory data) for a dependent variable identified as a target feature f_{T}. In another example, each feature fᵢ identifies one independent variable whose feature data is a time series while the target feature f_{T} identifies a dependent variable whose target data is also a time series. Each score sᵢ quantifies how well the feature fᵢ predicts the target feature f_{T} within a given prediction model. As known by those trained in the art, the term “feature” is synonymous with the terms “independent variable”, “input variable”, “predictor variable”, “covariate”, “exogenous variable”, and “explanatory variable”. Furthermore, the term “target feature” is synonymous with the terms “dependent variable”, “response variable”, “output variable”, “endogenous variable”, “target”, and “label”.

FIG. 1 also illustrates a method 100 for partitioning the candidate-feature ranking 106 into buckets 110. Each bucket 110 is a subset of the set of n_{f} features 102. The candidate-feature ranking 106 is split between the features fₚ_{₁} and fₚ_{₁}+1 to form a first bucket 110(1) that contains the first p₁ features {f₁, f₂, . . . , fₚ_{₁}₋₁, fₚ_{₁}} of the candidate-feature ranking 106. The candidate-feature ranking 106 is also split between the features fₚ_{₂} and fₚ_{₂}₊₁ to form a second bucket 110(2) that contains the next p₂−p₁ features {fₚ_{₁}₊₁, fₚ_{₁}₊₂, . . . fₚ_{₂}₋₁, fₚ_{₂}} of the candidate-feature ranking 106. The candidate-feature ranking 106 is also split between the features fₚ_{₃} and fₚ_{₃}₊₁ to form a third bucket 110(3) that contains the subsequent p₃−p₂ features {fₚ_{₂}₊₁, fₚ_{₂}₊₂, . . . fₚ_{₃}₋₁, fₚ_{₃}} of the candidate-feature ranking 106. The candidate-feature ranking 106 can be additionally split in this manner to form nₛ buckets 110. The integers p₁, p₂, etc. may also be referred to herein as “breakpoints”.

In the candidate-feature ranking 106, the score of each feature in the first bucket 110(1) is greater than or equal to the scores of every feature in the second bucket 110(2), the score of each feature in the second bucket 110(2) is greater than or equal to the score of every feature in the third bucket 110(3), and so on. Thus, the buckets 110 are also ranked, forming a bucket ranking 116 in which the first bucket 110(1) is the highest-ranked bucket, the second bucket 110(2) is the second highest-ranked bucket, and so on.

The method 100 may use one-dimensional clustering to identify the breakpoints p₁, p₂, etc. Such clustering is “one-dimensional” is that it is based only on the scores 104. There are many one-dimensional clustering techniques known in the art, any of which may be used with the method 100. For example, the features 102 may be binned based on the scores 104, with each bin corresponding to one bucket 110. The breakpoints may be based on quantiles, geometric progressions, or standard deviation. In another example, the breakpoints are determined using Jenk's natural breaks optimization or one-dimensional k-means clustering.

In some embodiments, the method 100 implements head/tail breaks, which is another example of a one-dimensional clustering technique. Head/tail breaks is particularly useful for heavy-tailed distributions. To implement head/tail breaks, the arithmetic mean of the scores is first calculated, i.e., s̅=(Σᵢⁿ^{_{f}} sᵢ)/n_{f}. The candidate-feature ranking 106 is then partitioned by identifying a single breakpoint closest to the mean s̅. Thus, each feature fᵢ whose score sᵢ is greater than s̅ is assigned to a head subset, and each feature fᵢ whose score sᵢ is less than s̅ is assigned to a tail subset. This process may be iterated with the head subset to produce a head-head subset and a head-tail subset, a head-head-head subset and a head-head-tail subset, and so on. Each of these head and tail subsets represents one of the buckets 110 shown in FIG. 1. The iterations may continue until the distribution of features f in the head subset is no longer heavy-tailed. Alternatively, head/tail breaks may be performed for a fixed number of iterations, or for a number of iterations that is determined from the candidate-feature ranking 106 (e.g., the number n_{f} of features 102, or a statistic of the scores 104).

Many of the above partitioning techniques produce buckets 110 with various sizes, where the size of a bucket 110 is the number of features 102 therein. However, the candidate-feature ranking 106 may be partitioned into equally-sized buckets 110. In this case, p₂=2p₁, p₃=3p₁, . . . , pₖ=kp₁, and so on. The last bucket 110(nₛ) may contain fewer than p₁ features. Furthermore, while FIG. 1 shows the features 102 ranked in descending order 112 of the scores 104, an alternative definition of score s may be used such that lower scores 104 correspond to more-relevant features 102. In this case, the features 102 may be ranked in ascending order such that the lowest score s corresponds to the most-relevant feature f.

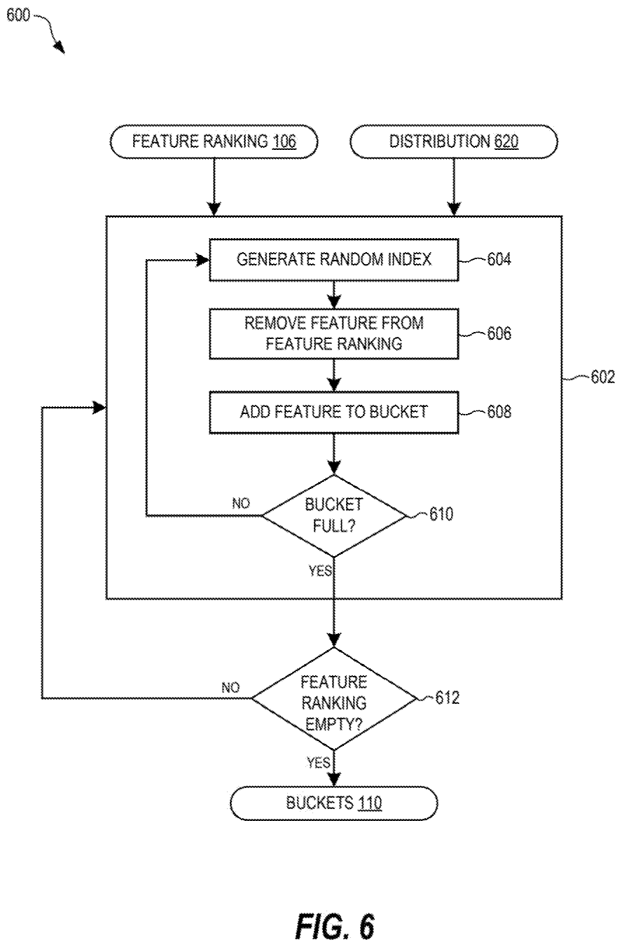

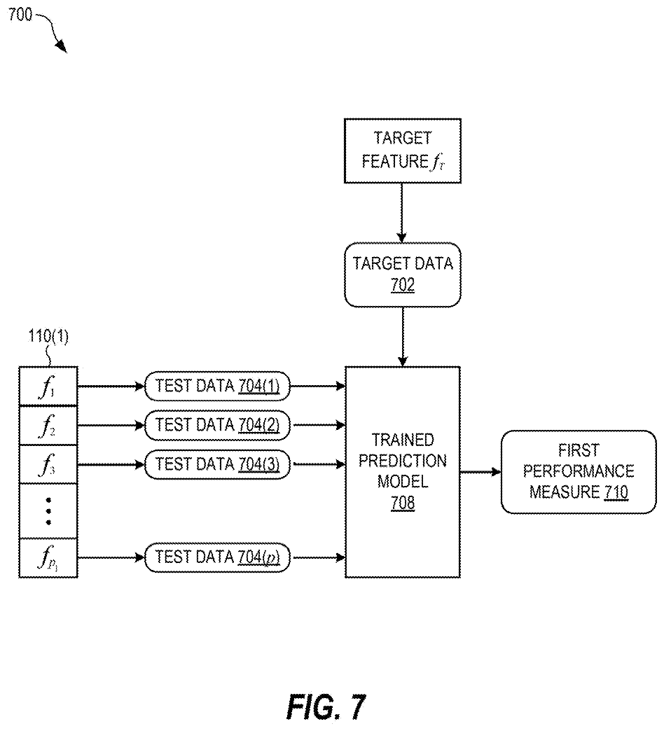

FIG. 2 illustrates a method 200 for updating the scores sᵢ of the p₁ features fᵢ of the first bucket 110(1), where i runs from 1 to p₁. First, training data 206 is generated by combining the target data from the target feature f_{T} with the feature data from the p₁ features fᵢ. A prediction model 208, such as a machine-learning classifier, is then trained with the training data 206. The trained prediction model 208 is then executed with the target data and feature data to determine score updates Δsᵢ for the p₁ features fᵢ. Each score update Δsᵢ quantifies the contribution, or importance, of the corresponding feature J to predicting the target feature f_{T} in the prediction model 208. The score updates Δsᵢ can be calculated using model-independent permutation-based methods, as described in more detail below (see FIGS. 6 and 7). For some types of prediction models, the score updates Δsᵢ can be calculated during training or using algorithms that are specific to a type of the prediction model 208. In any case, each score update Δsᵢ is used to update the corresponding score sᵢ⁽⁰⁾ to create an updated score sᵢ⁽¹⁾. For example, each score update Δsᵢ may be added to the corresponding score sᵢ⁽⁰⁾ to create an updated score, i.e., sᵢ⁽¹⁾=Δsᵢ+sᵢ⁽⁰⁾. The process for updating the score may be repeated for all of the buckets 110 to generate an updated score sᵢ⁽¹⁾ for all of the n_{f} features 102. Where the sizes of the buckets 110 vary, the prediction model 208 will need to be configured according to the number of features f included therein.

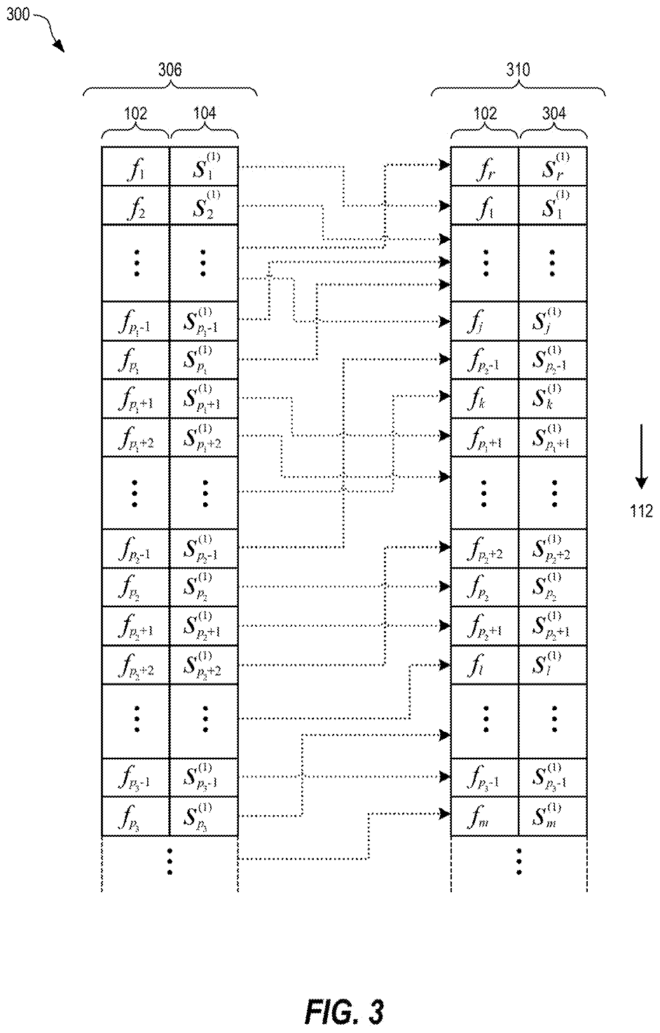

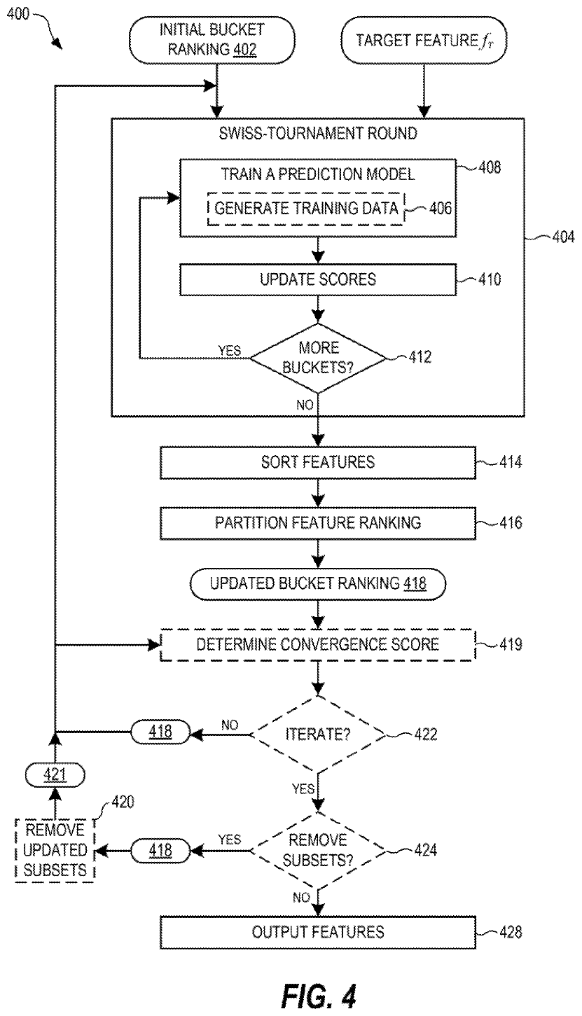

FIG. 3 illustrates a method 300 for sorting the features 102 based on the updated scores sᵢ⁽¹⁾. In FIG. 3, a candidate-feature list 306 is equal to the candidate-feature ranking 106 of FIG. 1 except that each score sᵢ⁽⁰⁾ has been replaced with its updated score sᵢ⁽¹⁾. The candidate-feature list 306 is then sorted based on the updated scores sᵢ⁽¹⁾ (e.g., in descending order 112) to produce an updated candidate-feature ranking 310. In the example of FIG. 3, some of the features 102 have gone down in ranking (e.g., f₁ and fₚ_{₁}₊₂), some of the features 102 have gone up in ranking (e.g., fᵣ, fₚ_{₁}₋₁, and fₚ_{₂}₊₂), and some of the features 102 have not changed in ranking (e.g., fₚ_{₃}₋₁ and fₚ_{₂}₊₁). However, after several iterations of the feature-selection method (see the method 400 of FIG. 4), the candidate-feature rankings 106 and 310 may converge such that most, if not all, of the highest-ranked features f do not change their position in the ranking with subsequent iterations. More details about how to determine convergence are presented below.

FIG. 4 is a flow chart of a feature-selection method 400. Advantageously, the method 400 can simultaneously rank hundreds of thousands of features 102, or more, enabling the most valuable (i.e. having the greatest predictive ability) to be identified and used for constructing a predictor. This ability to process so many features 102 optimizes the predictor's accuracy and minimizes the number of input variables needed to achieve a desired accuracy by rejecting non-orthogonal (i.e., redundant, correlated) features and irrelevant features that lead to overfitting of the predictor. As such, the method 400 is particularly beneficial for constructing predictors intended for use on edge devices and other computing systems whose resources (e.g., processor power, memory storage, throughput, etc.) limit the number of features 102 that can be processed.

The method 400 begins with an initial bucket ranking 402 of initial buckets that partition an initial candidate-feature ranking of candidate features. The bucket ranking 116 of FIG. 1 is one example of the initial bucket ranking 402. Each of the candidate features has an initial score (e.g., see the scores 104 of FIG. 1), wherein the candidate features of the initial candidate-feature ranking (e.g., see the candidate-feature ranking 106) are ranked based on the initial score. The method 400 also begins with an identified or inputted target feature f_{T}.

In the block 404, the method 400 iterates over the blocks 408 and 410 for each initial bucket of the initial bucket ranking 402. The block 404 may be thought of as one round of a Swiss tournament, where each initial bucket identifies participants of one competition of the round. The method 200 of FIG. 2 is an example of one iteration of the block 404. In the block 408, a prediction model (e.g., see prediction model 208) is trained with (i) feature data associated with each candidate feature of the each initial bucket and (ii) target data associated with the target feature f_{T}. The prediction model may be based on a neural network (e.g., deep neural network, recurrent neural network, convolutional neural network, etc.), a support vector machine, a random forest, linear regression, non-linear regression, logistic regression, a classifier (e.g., Bayes classifier), a time-series model (e.g., moving average, autoregressive, autoregressive integrated moving average, etc.), or another type of machine-learning or statistical model used. As an example of the block 408, the prediction model may be trained via backpropagation and gradient descent when the prediction model is a neural network.

In some embodiments, the block 408 includes the block 406 in which the training data is generated from the feature data and target data. In one example of the block 406, the feature data and target data are extracted from columns of a matrix of data values. In another example, the feature data associated with each feature is a time series, and the target data is also a time series. These time series are then combined to create the training data. When the time series do not align in time, methods known in the art (e.g., interpolation) may be used to align the time series.

In the block 410, the prediction model is used to update the initial score of each candidate feature into an updated score. With the block 412, the method 400 iterates over the blocks 408 and 410 to create updated scores for all of the candidate features in all of the initial buckets. In the block 414, the set of candidate features is sorted, based on the updated score, to create an updated candidate-feature ranking. The method 300 of FIG. 3 is one example of the block 414 (see the updated candidate-feature ranking 310). In the block 416, the updated candidate-feature ranking is partitioned, based on the updated score, to create an updated bucket ranking 418 of updated buckets. The method 100 is one example of the block 416, wherein the bucket ranking 116 is one example of the updated bucket ranking 418. In the block 428, one or more highest-ranked features of the updated bucket ranking 418 are outputted. The scores of these highest-ranked features may also be outputted. For example, a highest-ranked updated bucket may be outputted. However, additional highest-ranked updated buckets (e.g., a second-highest updated bucket, a third-highest updated bucket, etc.) may also be outputted without departing from the scope hereof. A subset, or portion, of an updated bucket may also be outputted in the block 428.

In some embodiments, the method 400 iterates over the blocks 404, 414, and 416. The method 400 may include a decision block 422 to determine if another iteration should be executed. In these embodiments, the updated bucket ranking 418 created during one iteration may be used as the initial bucket ranking 402 for the next iteration. Also in this case, the one or more highest-ranked features that are outputted in the block 428 may be selected from, and based on, the updated bucket ranking 418 created during a last iteration.

In some embodiments, the 400 includes the block 419, in which a convergence score is calculated based on the updated bucket ranking 418 and the initial bucket ranking 402. The decision block 422 may determine to iterate based on this convergence score. For example, a low convergence score (e.g., less than a threshold) may indicate that, in response to the most-recent iteration, many features changed which bucket they belong to (i.e., the method 400 has not converged). In this case, the method 400 starts a next iteration, using the updated bucket ranking 418 as the initial bucket ranking 402 for this next iteration. A high convergence score (e.g., above a threshold) may indicate that the updated bucket ranking 418 is so similar to the initial bucket ranking 402 that an additional iteration is unlikely to yield significant additional changes to bucket rank (i.e., the method 400 has converged). In this case, the method 400 may continue to the block 428. For clarity, an iteration of the method 400 via the decision block 422 is also referred to herein as a “convergence iteration”.

In some embodiments, the convergence score is a bucket-rank correlation score that quantifies how the candidate features moved between buckets as a result of the most-recent iteration. The bucket-rank correlation score assumes that all candidate features within any bucket have the same ranking as that bucket, and therefore there is no order or ranking of candidate features within the bucket. The bucket-rank correlation score may be computed by summing, for each feature, the absolute value of the difference between the rank of its initial bucket and the rank of its updated bucket. In another example, the bucket-rank correlation score computed for each iteration is stored in a history that is tracked to identify convergence. In this case, the decision block 422 may determine that the method 400 has converged based on a most-recent portion of the history, such as the presence of a “plateau” in the history. Another definition of the convergence score may be used without departing from the scope hereof. Furthermore, a convergence score is not necessary. For example, it may be determined that a predetermined number of iterations is sufficient and the number of iterations can be performed without calculating a convergence score. Alternatively, a convergence score can be calculated at a desired frequency, which can be predetermined or adjusted based on the convergence score.

In some embodiments, the method 400 includes a decision block 424 that determines if one or more updated buckets should be removed from the updated bucket ranking 418 prior to the next iteration. If so, the method 400 continues to the block 420, in which the one or more updated buckets are removed to form a truncated bucket ranking 421. The method 400 then returns to the block 404, using the truncated bucket ranking 421 for the initial bucket ranking 402. An iteration of the method 400 via the blocks 424 and 420 is also referred to herein as a “truncating iteration”.

In the block 420, the updated buckets to be removed are usually the lowest-ranked of the updated bucket ranking 418, and contain candidate features that offer little, if any, predictive ability for the target feature f_{T}. For example, when the block 416 implements head/tail breaks, the tail subset (i.e., the lowest-ranked of the updated buckets) may be discarded. Removing low-performing candidate features advantageously speeds up execution of subsequent iterations by reducing the total number n_{f} of candidate features to be processed. In practice, several convergence iterations may be needed to determine which candidate features consistently perform poorly and therefore should be removed. Accordingly, several convergence iterations may occur sequentially before a truncating iteration.

The removal of one or more updated buckets from the updated bucket ranking 418 usually causes the convergence score to drop in the next iteration. To better understand this effect, consider that the removal of one or more lowest-ranked updated buckets is equivalent to truncating the tail end of the distribution of updated scores. Thus, after one truncating iteration, several convergence iterations are usually necessary for this truncated distribution to “smooth out” and form a new tail that can be subsequently truncated via another truncating iteration. The removal of low-ranking features is also referred to herein as “pruning”.

The method 400 may continue iterating (both truncating and convergence iterations) until the candidate features remaining in the updated bucket ranking 418, or the top-ranked bucket of the bucket ranking 418, all have sufficiently high predictive abilities for the application at hand. When this occurs, the method 400 may then continue to the block 428 to output part or all of the updated bucket ranking 418 of the most-recent iteration. Alternatively, the method 400 may continue iterating until the number of candidate features in the updated bucket ranking 418 falls below a threshold. However, one or more other criteria may be used to determine when the method 400 stops iterating without departing from the scope hereof. These one or more criteria may be based, for example, on the updated bucket ranking 418, the initial bucket ranking 402, the scores of the candidate features, or a statistic derived thereof. Alternatively, the method 400 may perform a fixed or predetermined number of truncating iterations, and/or a fixed or predetermined number of convergence iterations per truncating iteration. Other techniques to determine when the method 400 stops iterating may be used without departing from the scope hereof.

In some embodiments, prior to a first iteration of the method 400, all of the candidate features have scores initialized to an initial value (e.g., zero). In this case, the candidate features may be randomly assigned to initial buckets 110. This use of randomness may advantageously help the method 400 avoid converging into local optima, as optimized to the desired global optimum. For example, for a given set of features, the method 400 may be repeated several times, each with a different randomly-constructed initial bucket ranking 116. The results of these repetitions may be compared to determine robustness and check for consistency. Features that are always identified by the method 400, regardless of the initial rankings, are in fact more likely to be the ones with the highest predictive abilities. On the other hand, features that are only sometimes identified by the method 400 indicate that the method 400 may not be fully converging to the global optimum, instead getting “stuck” in a local optimum.

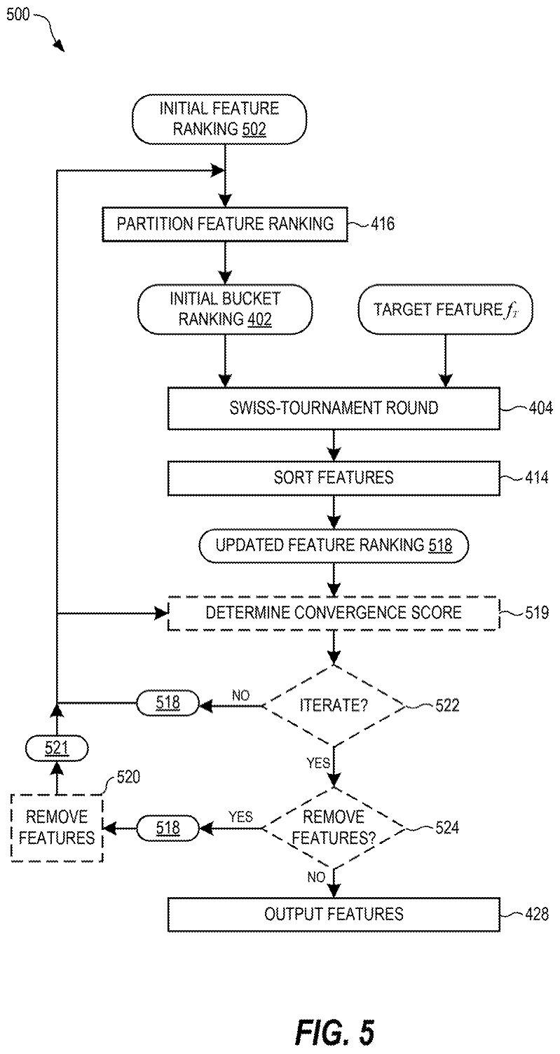

FIG. 5 is a flow chart of a feature-selection method 500 that is similar to the feature-selection method 400 of FIG. 4 except that bucket ranking is not explicitly used to determine the convergence score. The method 500 begins with an initial candidate-feature ranking 502 and a target feature f_{T}. The method 500 also includes the block 416, in which the initial candidate-feature ranking 502 is partitioned into the initial bucket ranking 402. The method 500 also includes the block 404, which implements one round of a Swiss tournament. Although not shown in FIG. 5 for clarity, the block 404 may also include the blocks 408, 410, and 412 (as shown in FIG. 4). The method 500 also includes the block 414, in which the candidate features are sorted, based on the updated score, to create an updated candidate-feature ranking 518 (e.g., see the updated candidate-feature ranking 310 of FIG. 3).

In some embodiments, the method 500 iterates over the blocks 416, 404, and 414. The method 500 may include a decision block 522 to determine if another iteration should be executed. In these embodiments, the updated candidate-feature ranking 518 created during one iteration may be used as the initial candidate-feature ranking 502 for the next iteration. Also in this case, the one or more highest-ranked features that are outputted in the block 428 may be selected from, and based on, the updated candidate-feature ranking 518 created during a last iteration.

In some embodiments, the method 500 includes the block 519, in which a convergence score is calculated based on the updated candidate-feature ranking 518 and the initial candidate-feature ranking 502. The decision block 422 may determine to iterate based on this convergence score. Thus, the method 500 differs from the method 400 in that convergence and iterating are determined from candidate-feature rankings 502 and 518, rather than bucket rankings. For example, a low convergence score may indicate that, in response to the most-recent iteration, many features changed their position between the initial candidate-feature ranking 502 and the update candidate-feature ranking 518 (i.e., the method 500 has not converged). In this case, the method 500 returns to the block 416 to start a next iteration, using the updated candidate-feature ranking 518 as the initial candidate-feature ranking 502 for this next iteration. A high convergence score may indicate that the updated candidate-feature ranking 518 is so similar to the initial candidate-feature ranking 502 that an additional iteration is unlikely to yield significant additional changes to candidate-feature rank (i.e., the method 400 has converged). In this case, the method 500 may continue to the block 428. For clarity, an iteration of the method 500 via the decision block 522 is also referred to herein as a “convergence iteration”.

In some embodiments, the convergence score is a feature-rank correlation score that quantifies how the candidate-feature rank changed as a result of the most-recent iteration. The feature-rank correlation score assumes that each candidate feature has a unique rank between 1 and n_{f} (i.e., no two candidate features have the same ranking). The feature-rank correlation score may be computed by summing, for each feature, the absolute value of the difference between its position in the initial candidate-feature rank 502 and its position in the updated candidate-feature rank 518. In another example, the candidate-rank correlation score computed for each iteration is stored in a history that is tracked to identify convergence. In this case, the decision block 522 may determine that the method 500 has converged based on a most-recent portion of the history, such as the presence of a “plateau” in the history. Another definition of the convergence score may be used without departing from the scope hereof.

In some embodiments, the method 500 includes a decision block 524 that determines if one or more lowest-ranked candidate features should be removed from the updated candidate-feature ranking 518 prior to the next iteration. If so, the method 500 continues to the block 520, in which the one or more lowest-ranked candidate feature are removed to form a truncated feature ranking 521. The method 500 then returns to the block 416, using the truncated feature ranking 521 for the initial candidate-feature ranking 502. An iteration of the method 500 via the blocks 524 and 520 is also referred to herein as a “truncating iteration”.

In some embodiments, a number of the lowest-ranked candidate features to be removed in the block 520 is based on an iteration number of the method 500 (i.e., how many times the method 500 has already iterated over the blocks 416, 404, and 414), or the number of convergence iterations that occurred since the last truncating iteration. In some embodiments, the number of the features to be removed is a percentage of the number of features in the updated candidate-feature ranking 518. In some embodiments, each feature to be removed has a score less than or equal to a percentage of a highest score of the updated candidate-feature ranking 518. The percentage may be selected based on the iteration number of the method 500. Other techniques to determine which of the lowest-ranked candidate features to remove may be used without departing from the scope hereof.

Similar to the method 400, the removal of lowest-ranked candidate features from the updated candidate-feature ranking 518 usually causes the convergence score to drop in the next iteration. Thus, the method 500 may continue iterating (both truncating and convergence iterations) until the candidate features remaining in the updated candidate-feature ranking 518 all have sufficiently high predictive abilities for the application at hand. When this occurs, the method 500 may then continue to the block 428. Alternatively, the method 500 may continue iterating until the number of candidate features in the updated candidate-feature ranking 518 falls below a threshold. However, one or more other criteria may be used to determine when the method 500 stops iterating without departing from the scope hereof. These one or more criteria may be based, for example, on the updated candidate-feature ranking 518, the initial candidate-feature ranking 502, the scores of the candidate features, or a statistic derived thereof. Alternatively, the method 500 may perform a fixed or predetermined number of truncating iterations, and/or a fixed or predetermined number of successive convergence iterations between each pair of truncating iterations. Other techniques to determine when the method 500 stops iterating, such as those discussed for the method 400, may be used without departing from the scope hereof.

FIG. 6 illustrates a random partitioning method 600 that may be used with the method 500 to increase the likelihood that the method 500 converges to the global optimum instead of a local optimum. In embodiments, the method 600 implements the block 416 of the methods 400 and 500, providing an additional source of randomness that is conceptually similar to temperature-based random fluctuations used in simulated annealing and random mutations used in genetic algorithms. In the block 602, a bucket 110(i) of size nᵢ is generated for each iteration i. Within the block 602, the blocks 604, 606, and 608 iterate nᵢ times, i.e., once for each candidate feature to be inserted to the bucket 110(i). In the block 604, an index is randomly generated according to a distribution 620. The index may be scaled such that it is an integer between one and a current size of the candidate-feature ranking 106. In the block 606, the feature located in the candidate-feature ranking 106 at the index is removed from the initial candidate-feature ranking 106, thereby reducing the size of the initial candidate-feature ranking 106 by one. In the block 608, the removed feature is inserted to the bucket 110(i). If, at the block 610, the bucket 110(i) is not full, then the method 600 returns to the block 604 to add to the bucket 110(i) another remaining feature of the candidate-feature ranking 106. If, at the block 610, the bucket 110(i) is full, then the method 600 passes to the block 612. If, at the block 612, the candidate-feature ranking 106 is not empty (i.e., its current size is greater than zero), then the method 600 returns to the block 602 to generate a next bucket 110(i+1). If, at the block 612, the candidate-feature ranking 106 is empty, then all of the buckets 110 are returned and the method 600 ends.

The probability distribution 620 may be selected such that the randomly generated index is more likely to have a low value (i.e., the corresponding feature is highly ranked in the candidate-feature ranking 106). In this case, the randomly generated indices will mostly correspond to the highest-ranked features that would have been selected without the randomness (e.g., as shown in FIG. 1). Only a few, if any, lower-ranked features will be selected for inclusion in higher-ranked buckets. The type of probability distribution 620 and its parameters may be selected to change how much randomness is added (i.e., how many lower-ranked features are added to the bucket 110(i)). On one extreme, the probability distribution 620 may be so sharply peaked at index number 1 that the method 600 always selects the highest-ranked remaining feature, and therefore generates the exact same buckets 110 as the method 100. In this case, the method 600 does not introduce any significant randomness. On the other extreme, the probability distribution 620 may be flat, in which case every feature is selected completely at random, leading to buckets with approximately equal mixtures of high- and low-ranked features.

In some embodiments, the probability distribution 620 is a geometric distribution whose probability density distribution decreases exponentially with index. With the geometric distribution, the probability of randomly selecting an index i is greater than the probability of selecting any index greater than i (i.e., i+1, i+2, . . . ), and therefore the highest-ranked feature is the most likely to be selected. The shape of the geometric distribution may be changed via a parameter p with 0<p<1. Alternatively, the probability distribution 620 may be a negative binomial distribution, a Poisson distribution, a chi-squared distribution, an exponential distribution, a Laplace or double exponential distribution, a hypergeometric distribution, or another type of distribution used for probability theory and statistics.

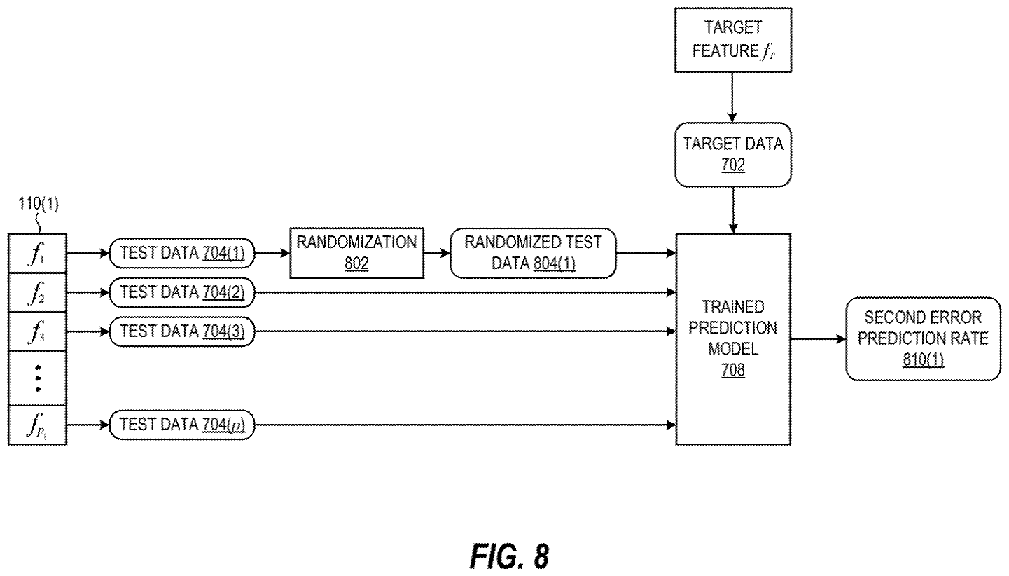

FIGS. 7 and 8 illustrate a permutation-based method 700 for calculating score updates Δs. Advantageously, the method 700 can be used with any type of prediction model 208. In FIG. 7, test data 704 associated with each of the p₁ candidate features 102 in the first bucket 110(1) are inputted to a trained prediction model 708. Target data 702 associated with the target feature f_{T} are also inputted to the prediction model 708, which outputs a first performance measure 710 that quantifies how well the prediction model 208 can recreate the target data 702. The test data 704 and target data 702 may be the same training data 206 used to train the prediction model 208 (e.g., as shown in FIG. 2). Alternatively, the test data 704 and target data 702 may be obtained from a holdout data set, as is commonly used for cross-validation. The first performance measure 710 may be a classification accuracy (e.g., when the prediction model 708 is a classifier), final value of a cost or loss function (e.g., a sum of squared residuals), entropy, error rate, mutual information, correlation coefficient, or another type of metric used to quantify model performance.

FIG. 8 shows the test data 704 and target data 702 being inputted to the trained prediction model 708 to obtain a second performance measure 810(1) that quantifies the performance of the prediction model 708 in the absence of the first feature f₁. However, instead of training a new model with one fewer feature, which would incur significant computational resources, the test data 704(1) for the first feature f₁ is randomized (see randomization 802) to create randomized test data 804(1) that is inputted to the trained prediction model 708. This randomization is equivalent to replacing the test data 704(1) with noise. The second performance measure 810(1) is therefore equivalent to the first performance measure 710 except that the impact of the first feature f₁ has been essentially excluded. The test data 704(1) may be randomized by replacing each data point therein with a randomly-generated value. Alternatively, the test data 704(1) may be randomized by randomly permuting the data points.

The performance measures 710 and 810(1) may be compared to determine the score update Δs₁. For example, the score update Δs₁ may be selected to be the difference between the performance measures 710 and 810(1). In general, the more relevant a feature, the greater the difference and therefore the greater the score update Δs. Thus, more relevant features quickly accumulate larger scores s, causing them to rise in rank faster than less relevant features. Another method for calculating the score update Δs from the performance measures 710 and 810(1) may be used without departing from the scope hereof.

The method illustrated in FIG. 8 may be repeated for each of the p₁ features of the first bucket 110(1) to generate p₁ corresponding second performance measures 710(1), 710(2), . . . , 710(p₁) from which p₁ corresponding score updates Δs₁, Δs₂, . . . , Δsₚ are calculated. The method 700 then repeats for each bucket 110 until one score update Δs has been calculated for each of the n_{f} features of the candidate-feature ranking 106.

Embodiments with Multiple Target Features

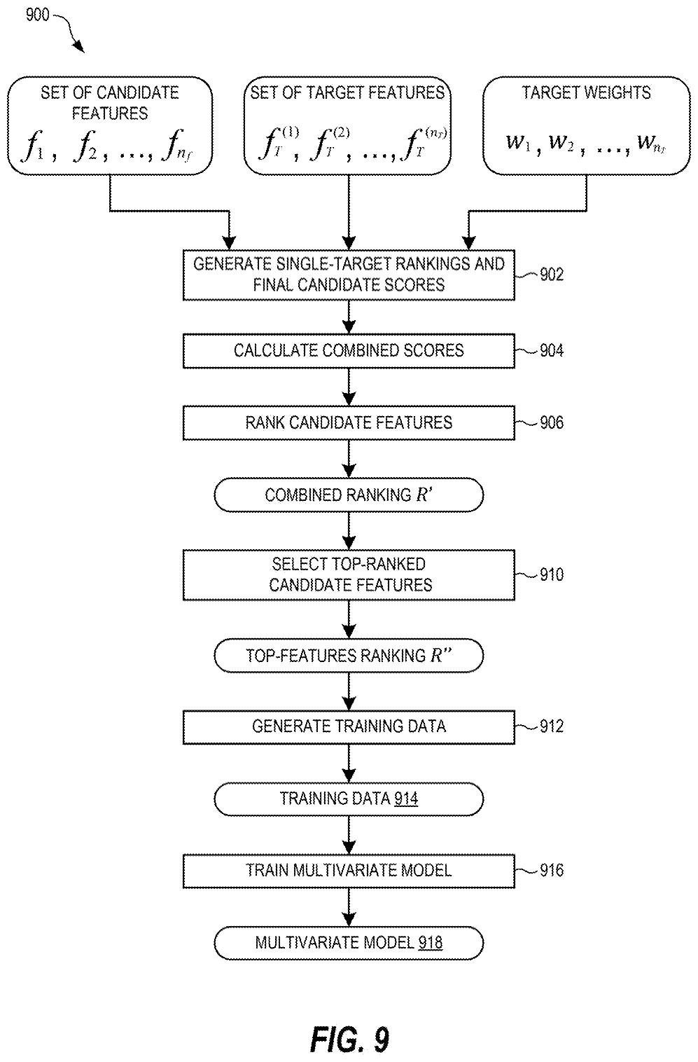

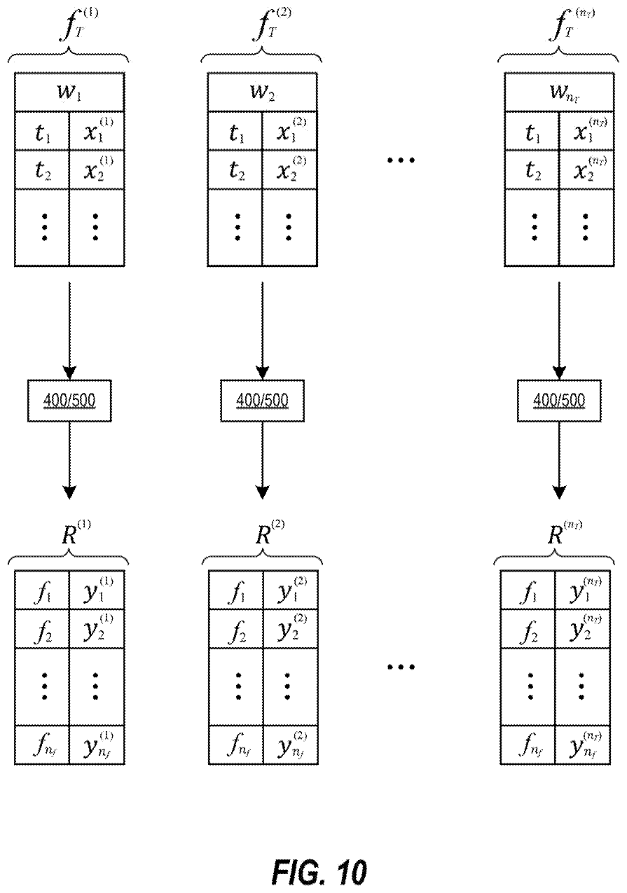

FIG. 9 is a flow chart of a method 900 for constructing a multivariate prediction model 918. The method 900 may use the method 400 (or alternatively the method 500) to identify which candidate features, of set of n_{f} candidate features f₁, f₂, . . . , fₙ_{_{f}}, collectively provide the best predictive ability for a set of n_{T} target features f_{T}⁽¹⁾, f_{T}⁽²⁾, . . . f_{T}⁽ⁿ^{_{T}}⁾. Associated with each target feature f_{T}⁽ⁱ⁾ is a corresponding target-feature weight wᵢ that quantifies the relative importance of the target feature f_{T}⁽ⁱ⁾ relative to the other target features. FIGS. 10-12 illustrate various parts of the method 900. FIGS. 9-12 are best viewed together with the following description. For clarity, each of the target features may be simply referred to as a “target” and each of the target-feature weights may be simply referred to as a “weight”.

FIG. 10 illustrates the block 902 of the method 900 in more detail. In the block 902, single-target rankings and final candidate scores are generated. As shown in FIG. 10, associated with a first target f_{T}⁽¹⁾ is a first weight w₁ and a first time series of data points of the form {(t₁, x₁⁽¹⁾), (t₂,x₂⁽¹⁾), (t₃,x₃⁽¹⁾), . . . }. For clarity in FIG. 10, the first time-series is shown as a column of time values tᵢ and a column of target-feature values xᵢ, where xᵢ represents the target-feature value at the time tᵢ and the superscript “(1)” identifies the target f_{T}⁽¹⁾. Each of the other targets also has an associated weight and time series of data points. For example, associated with a second target f_{T}⁽²⁾ is a second weight w₁ and a second time series of data points of the form {(t₁, x₁⁽²⁾), (t₂,x₂⁽²⁾), (t₃,x₃⁽²⁾), . . . }. Similarly, associated with a final feature f_{T}⁽ⁿ^{_{T}}⁾ is a final weight wₙ_{_{T}} and a final time series of data points of the form {(t₁, x₁⁽ⁿ^{_{T}}⁾), (t₂, x₂⁽ⁿ^{_{T}}⁾), (t₃, x₃⁽ⁿ^{_{T}}⁾), . . . }.

As shown in FIG. 10, the method 400 (or alternatively the method 500) is executed using the first time series of the first target f_{T}⁽¹⁾ as the target data. Although not shown in FIG. 10, candidate-feature data associated with the candidate features f₁, f₂, . . . fₙ_{_{f}} is also inputted to the method 400. The method 400 processes the first time series and the candidate-feature data to identify the highest-ranking candidate features and their corresponding scores. This output of the method 400 is shown in FIG. 10 as a first single-target ranking R⁽¹⁾ of n_{f} final candidate scores {y₁⁽¹⁾, y₂⁽¹⁾, . . . , yₙ_{_{f}}⁽¹⁾}, corresponding to the n_{f} candidate features f₁, f₂, . . . , fₙ_{_{f}}. For each candidate feature removed by the method 400, the corresponding final candidate score may be zero. As indicated in FIG. 10, the method 400 is iterated n_{T} times, each iteration using the time series of a different target as the target data, to obtain a set of n_{T} single-target rankings R⁽¹⁾, R⁽²⁾, . . . , R⁽ⁿ^{_{T}}⁾. The same candidate-feature data is used for all of the iterations.

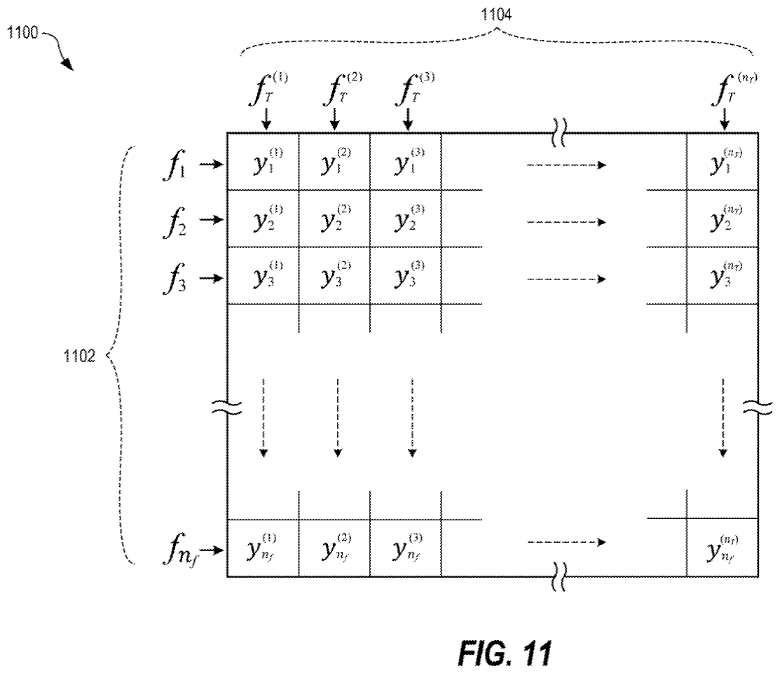

FIG. 11 shows a feature-score matrix 1100 storing the final candidate scores of the n_{T} single-target rankings R⁽¹⁾, R⁽²⁾, R⁽ⁿ^{_{T}}⁾. Although the matrix 1100 is not necessary to perform the method 900, it is shown to illustrate one way in which the final candidate scores may be simply organized. The matrix 1100 includes n_{f} rows 1102 corresponding to the n_{f} candidate features f₁, f₂, . . . , fₙ_{_{f}}, and n_{T} columns 1104 corresponding to n_{T} targets f_{T}⁽¹⁾, f_{T}⁽²⁾, . . . , f_{T}⁽ⁿ^{_{T}}⁾. Each cell of the matrix 1100 stores one final candidate score yᵢ^{(j)} corresponding to the candidate feature fᵢ and the target f_{T}^{(j)}. Thus, the columns 1104 correspond to the single-target rankings R⁽¹⁾, R⁽²⁾, . . . , R⁽ⁿ^{_{T}}⁾. The matrix 1100 may be alternatively arranged with n_{T} rows 1102 corresponding to the n_{T} targets and n_{f} columns 1104 corresponding to the n_{f} candidate features.

In the block 904, a combined score cᵢ is calculated for each candidate feature fᵢ of the set of candidate features f₁, f₂, . . . , fₙ_{_{f}}. The combined score cᵢ is a weighted sum of the n_{T} final candidate scores yᵢ⁽¹⁾, yᵢ⁽²⁾, . . . , yᵢ⁽ⁿ^{_{T}}⁾ for the candidate feature as obtained from the n_{T} single-target rankings R⁽¹⁾, R⁽²⁾, . . . , R⁽ⁿ^{_{T}}⁾. Mathematically, cᵢ=Σⱼ₌₁ⁿ^{_{T}} wⱼyᵢ^{(j)}. For the candidate feature fᵢ, the final candidate scores yᵢ⁽¹⁾, yᵢ⁽²⁾, . . . , yᵢ⁽ⁿ^{_{T}}⁾ are stored in the i^{th} row 1102 of the feature-score matrix 1100. In the block 906, the candidate features are ranked based on the combined score to form a combined ranking R′. In the block 910, a plurality of top-ranked candidate features are selected from the combined ranking R′. These top-ranked candidate features form a top-features ranking R″. The top-features ranking R″ may be formed, for example, by selecting the first k top-ranked candidate features of the combined ranking R′, for some positive integer k.

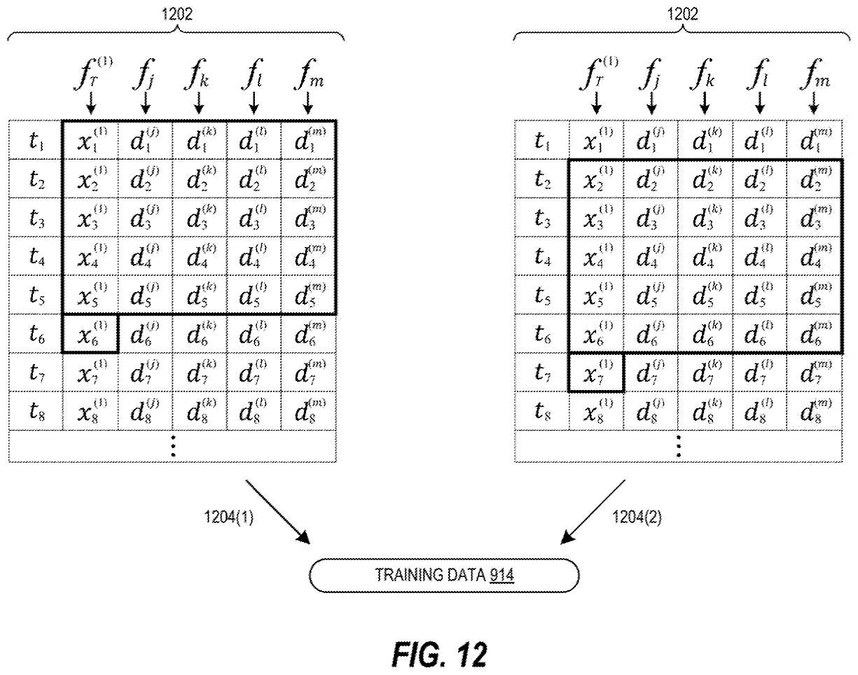

FIG. 12 illustrates the block 912 of the method 900 in more detail. In the block 912, training data 914 is generated for each of the targets f_{T}⁽¹⁾, f_{T}⁽²⁾, . . . , f_{T}⁽ⁿ^{_{T}}⁾. In the block 916, the training data 914 is used to train the multivariate model 918. Accordingly, the form of the multivariate model 918 (e.g., number of inputs, outputs, and internal connections) is predetermined such that training samples of the training data 914 can be constructed to match the form of the multivariate model 918. In the example of FIG. 12, only the first target f_{T}⁽¹⁾ is considered, and the multivariate model 918 is assumed to a vector time-series model with five lags and five variables. FIG. 12 shows a multivariate time series 1202 formed by combining the univariate time series of the first target f_{T}⁽¹⁾ and the univariate time series of each of four top-ranked candidate features fⱼ, fₖ, fₗ, and fₘ, where dᵢ^{(g)} represents the value of the candidate feature f_{g} at the time step tᵢ. Without departing from the scope hereof, additional or fewer top-ranked candidate features may be included in the multivariate time series 1202, depending on the architecture of the prediction model 918.

To generate a first training sample 1204(1) from the multivariate time series 1202, all of the data for the first five consecutive time steps t₁, . . . t₅ is selected as an input object. For clarity in FIG. 12, the input object is outlined in black. The next succeeding value of the target f_{T}⁽¹⁾, or x₆⁽¹⁾, is then selected as the supervisory signal and combined with the input object to form the first training sample 1204(1). Again, for clarity, the supervisory signal is outlined in black. The choice of five consecutive time steps is due to the use of five lags in the selected time-series model. If a time-series model with a different number of lags is selected, then the number of the consecutive time steps selected for the input object should be adjusted accordingly.

To generate a second training sample 1204(2) from the multivariate time series 1202, all of the data for the next five consecutive time steps t₂, . . . t₆ is selected as an input object. The next succeeding value of the first target f_{T}⁽¹⁾, or x₇⁽¹⁾, is then selected as the supervisory signal and combined with the input object to form the second training sample 1204(2). This process may be repeated using each subsequent value of first target f_{T}⁽¹⁾ as the supervisory signal, ending when a final value of the target f_{T}⁽¹⁾ is used as the supervisory signal. At this point, the process may be repeated with the time-series data of the first target f_{T}⁽¹⁾ replaced with the time-series data of each of the other targets.

The accuracy of the multivariate model 918 may be checked, for example, using a hold-out data set. If the accuracy is insufficient (e.g., below a predetermined threshold), the method 900 may be iterated by returning to the block 910 and enlarging the top-features ranking R″ to include one or more of the next top-ranked candidate features of the combined ranking R′ (i.e., the one or more top-ranked candidate features that were not previously included in the top-features ranking R″). By including additional candidate features in the top-features ranking R″, the form of the multivariate model 918 may need to be expanded accordingly. The method 900 may continue iterating, with each iteration adding additional top-ranked candidate features to the top-features ranking R″, until the accuracy of the trained multivariate model 918 reaches or exceeds the predetermined target threshold. Thus, by iterating in this manner, the method 900 identifies a minimum number of the candidate features necessary to reach the target threshold, advantageously preventing lower-ranked candidate features from being included in the multivariate model 918.

Alternatively, if the accuracy of the multivariate model 918 exceeds the target threshold, the method 900 may be iterated with fewer top-ranked candidate features in the top-features ranking R″. By removing candidate features from the top-features ranking R″, the form of the multivariate model 918 may need to be adjusted accordingly. Advantageously, removing candidate features from the top-features ranking R″ reduces the computational resources needed to execute the multivariate model 918 by simplifying the multivariate model 918 and excluding features that contribute the least to accuracy.

In embodiments, the method 900 includes using, after training, the multivariate model 908 to generate a prediction. In these embodiments, the method 900 may include receiving a data object to input to the multivariate model 908. The method 900 may then output the prediction. In other embodiments, the method 900 includes outputting, after training, the multivariate model 918, which may include a list of which candidate features are used as inputs for the multivariate model 918 (i.e., the candidate features of the top-features ranking R″). For example, the multivariate model 918 may be transmitted to another computer system that uses the multivariate model 918 for prediction and classification. Other data generated by the method 900 (e.g., single-target rankings, final candidate scores, accuracy against a hold-out data set, etc.) may also be outputted with the multivariate model 918.

System Embodiments

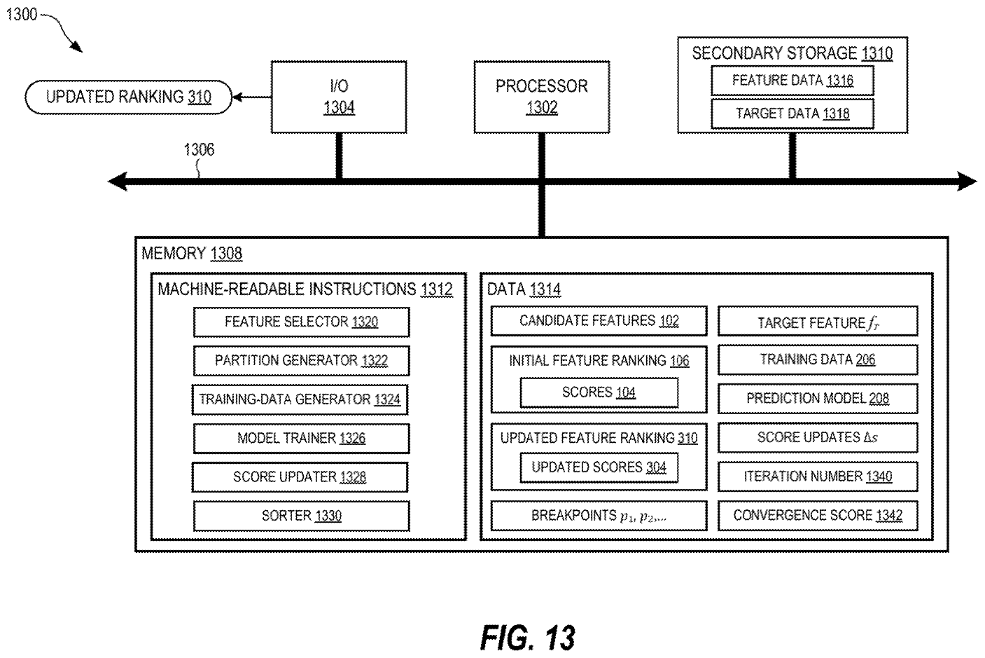

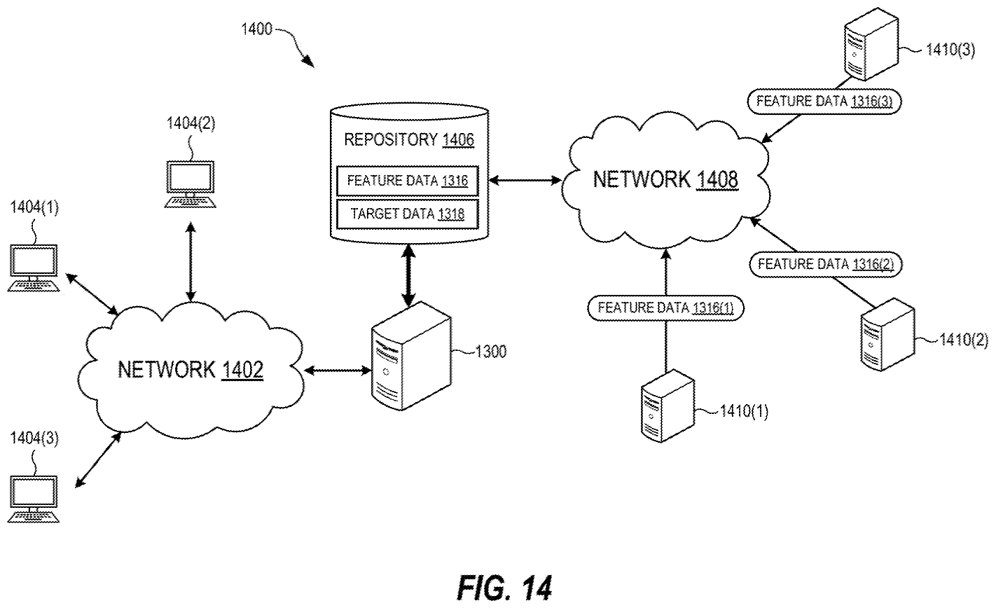

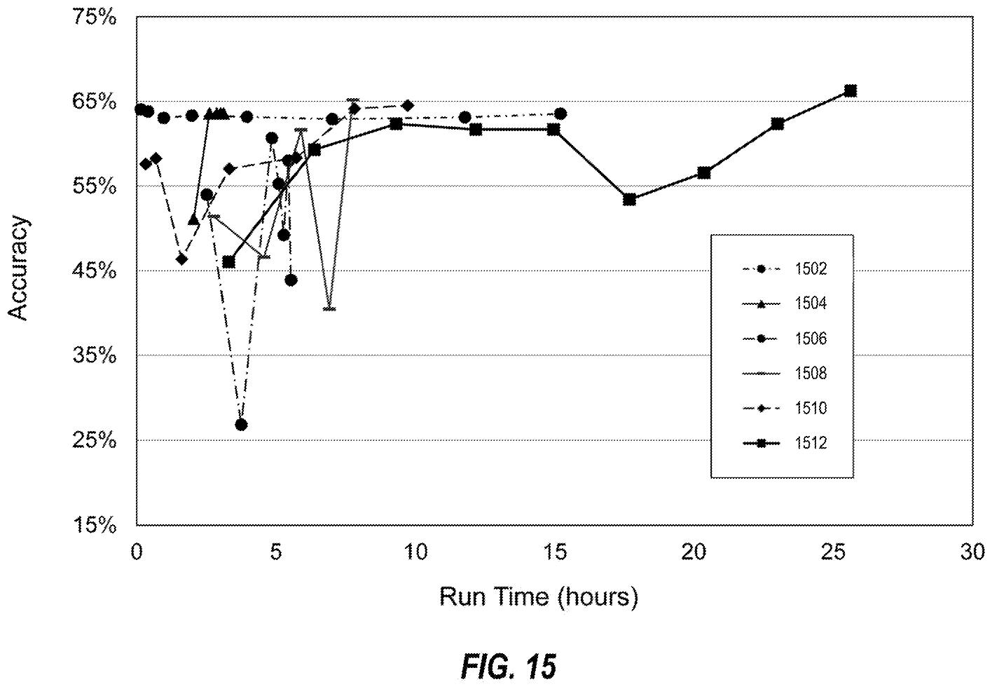

FIG. 13 is a functional diagram of a feature-selection system 1300 that implements the present method embodiments. The feature-selection system 1300 is a computing device having a processor 1302, memory 1308, and secondary storage device 1310 that communicate with each other over a system bus 1306. For example, the memory 1308 may be volatile RAM located proximate to the processor 1302, while the secondary storage device 1310 may be a hard disk drive, a solid-state drive, an optical storage device, or another type of persistent data storage. The secondary storage device 1310 may alternatively be accessed via an external network instead of the system bus 1306 (e.g., see FIG. 14). Additional or other types of the memory 1308 and the secondary storage device 1310 may be used without departing from the scope hereof.

The feature-selection system 1300 includes at least one I/O block 1304 that outputs some or all of the updated ranking 310 to a peripheral device (not shown). For example, the I/O block 1304 may output the one or more highest-ranked candidate features 102 of the updated candidate-feature ranking 310, thereby implementing the block 428 of the methods 400 and 500. The I/O block 1304 is connected to the system bus 1306 and therefore communicates with the processor 1302 and the memory 1308. In some embodiments, the peripheral device is a monitor or screen that displays the outputted candidate features in a human-readable format (e.g., as a list). Alternatively, the I/O block 1304 may implement a wired network interface (e.g., Ethernet, Infiniband, Fibre Channel, etc.), wireless network interface (e.g., WiFi, Bluetooth, BLE, etc.), cellular network interface (e.g., 4G, 5G, LTE), optical network interface (e.g., SONET, SDH, IrDA, etc.), multimedia card interface (e.g., SD card, Compact Flash, etc.), or another type of communication port.

The processor 1302 may be any type of circuit or integrated circuit capable of performing logic, control, and input/output operations. For example, the processor 1302 may include one or more of a microprocessor with one or more central processing unit (CPU) cores, a graphics processing unit (GPU), a digital signal processor (DSP), a field-programmable gate array (FPGA), a system-on-chip (SoC), a microcontroller unit (MCU), and an application-specific integrated circuit (ASIC). The processor 1302 may also include a memory controller, bus controller, and other components that manage data flow between the processor 1302, the memory 1308, and other components connected to the system bus 1306.

The memory 1308 stores machine-readable instructions 1312 that, when executed by the processor 1302, control the feature-selection system 1300 to implement the functionality and methods described herein. The memory 1308 also stores data 1314 used by the processor 1302 when executing the machine-readable instructions 1312. In the example of FIG. 13, the data 1314 includes the set of n_{f} candidate features 102, the initial candidate-feature ranking 106 and initial scores 104, the updated candidate-feature ranking 310 and updated scores 304, the breakpoints, the target feature f_{T}, the training data 206, the prediction model 208, the score updates Δs, an iteration number 1340 identifying how many iterations have been executed, and a convergence score 1342. The memory 1308 may store additional data 1314 than shown. In addition, some or all of the data 1314 may be stored in the secondary storage device 1310 and fetched from the secondary storage device 1310 when needed. In the example of FIG. 13, the secondary storage device 1310 stores feature data 1316 and target data 1318. However, secondary storage device 1310 may store additional or other data than shown without departing from the scope hereof.

In the example of FIG. 13, the machine-readable instructions 1312 include a feature selector 1320 that implements the feature-selection method 400 of FIG. 4 (or alternatively the feature-selection method 500 of FIG. 5). The feature selector 1320 may call one or more of a partition generator 1322, a training-data generator 1324, a model trainer 1326, a score updater 1328, a sorter 1330, and other machine-readable instructions 1312. The partition generator 1322 generates the buckets 110 from the initial candidate-feature ranking 106 to implement the block 416 of the method 400. The training-data generator 1324 fetches the feature data 1316 and the target data 1318 from the secondary storage device 1310 and generates the training data 206, thereby implementing the block 406 of the method 400. The model trainer 1326 trains the prediction model 208 with the training data 206, thereby implementing the block 408 of the method 400. The score updater 1328 calculates the score updates Δs and updates the scores 104 with the score updates Δs to generate the updated scores 304, thereby implementing the block 410 of the method 400. The sorter 1330 sorts the candidate features 102 based on the updated scores 304 to create the updated candidate-feature ranking 310, thereby implementing the block 414 of the method 400. The memory 1308 may store additional machine-readable instructions 1312 than shown in FIG. 13 without departing from the scope hereof.

FIG. 14 is a functional diagram of a big-data system 1400 that expands the feature-selection system 1300 of FIG. 13 to operate with a data repository 1406. In many cases, the number of features n_{f} to be considered during feature selection is so large (e.g., millions, or more) that the corresponding quantity of feature data 1316 and target data 1318 requires a computer architecture designed for big-data applications. To address the challenges of these situations, the feature-selection system 1300 may interface with the data repository 1406, which is designed to store and quickly retrieve such large volumes of data. The data repository 1406 may be a data lake, a data warehouse, a database server, or another type of big-data or enterprise-level storage system. In some embodiments, the data repository 1406 is implemented as cloud storage that the feature-selection system 1300 accesses remotely (e.g., over the internet). The feature-selection system 1300 may be, or form part of, a supercomputer, a computer cluster, a distributed computing system, or another type of high-performance computing system with the resources to process the data.

In the example of FIG. 14, the data repository 1406 aggregates data retrieved from one or more data stores 1410. For example, the data repository 1406 may receive, via a network 1408 (e.g., the internet, a wide area network, a local area network, etc.), first feature data 1316(1) for a first candidate feature f₁ from a first data store 1410(1), second feature data 1316(2) for a second candidate feature f₂ from a second data store 1410(2), and so on. The data repository 1406 may store data that is structured (e.g., as in a relational database), unstructured (e.g., as in a data lake), semi-structured (e.g., as in a document-oriented database), or any combination thereof. The feature-selection system 1300 is configured as a server that communicates with one or more clients 1404 over a network 1402. Each client 1404 may interface with the feature-selection system 1300 (e.g., via the I/O block 1304) to start execution of the feature selector 1320, select candidate features for inclusion in the execution, and receive results (e.g., the one or more most-relevant features of the updated ranking 310).

The big-data system 1400 separates the tasks of collecting and integrating data 1316, 1318 from the task of feature selection, allowing users to advantageously focus on feature selection without the need to understand many, if any, technical details related to the data repository 1406. Furthermore, the network-based architecture shown in FIG. 14 allows many users to access and use the system 1400 simultaneously, and thereby benefit from the effort required to construct and maintain a storage system capable of handling such large quantities of data.

In one embodiment, a data lake of time-series data is collected from a plurality of sensors monitoring events outside of a moving vehicle. Where one of the sensors is a sensor that generates an image, the image can be separated into subsets of data that change over time, thus allowing a particular sensor to define multiple time series. Different sensors can provide data periodically such that the result is a substantial number of data series can be provided in real time from different sensors. Naturally, many of the time series will be insignificant for much of the time. Because the method disclosed can rapidly determine the elements that are the most predictive of a desired outcome without the need for unrealistic amounts of processing power, it is possible to determine the data series that have the greatest predictive significance and to adjust which data series are most predictive based on changing conditions. Naturally, the adjustment to selecting the most predictive elements could be done in the vehicle via edge computing or remotely via a server in communication with the vehicle. In addition, for a particular vehicle and set of sensors it is possible to expose the vehicle to a variety of different conditions and then determine the most predictive data series in advance for each type of condition. As can be appreciated, for example, the set of data series most important for highway driving might be different than the set of data series when in an urban environment or when another vehicle is in an adjacent lane. Similarly, the set of data series that were most predictive when the conditions were sunny and warm might be different that the set of data series that were most predictive in a blizzard. Thus, considerable flexibility exists to modify the set of data series that are considered the most significant.

Demonstrations

FIG. 15 is a plot of accuracy versus run-time that demonstrates the benefits of the present embodiments. The plot contains a data series 1502 that was obtained with a prior-art forward incremental feature-selection technique, and five data series (labeled 1504, 1506, 1508, 1510, and 1512) that were obtained using the present embodiments. For each of these demonstrations, 90,000 candidate features were considered and the same target feature f_{T} was used. Each candidate feature had corresponding feature data in the form a time series of monthly values extending up to thirteen years. Each data point in each of the data series 1504, 1506, 1508, 1510, and 1512 was determined after ten iterations of the method 400, i.e., after ten rounds of the Swiss tournament block 404. All demonstrations were performed on a computer system with 72 cores and 144 GB of memory.

Pruning was implemented differently for each demonstration of the present embodiments. For each pruning step, the mean μ and standard deviation σ was calculated from the candidate ranking. All candidate features with a score less than μ−ασ were then removed (or truncated) from the ranking, where a is a pruning parameter. For the data series 1504, 1506, 1508, 1510, and 1512, a was set to 1.15, 1.28, 1.44, 1.64, and 1.96, respectively. Pruning was applied after each round (e.g., after each execution of the Swiss tournament block 404 of the method 400). However, at the beginning of each demonstration, pruning sometimes resulted in no candidate parameters being removed, especially at the beginning of each demonstration, when features were still moving significantly throughout the ranking from one round to the next.

Table 1 summarizes the results of FIG. 15. The prior-art incremental feature selection is referred to as the “baseline”, as it represents state-of-the-art performance. The data series 1508, 1510, and 1512 each achieve accuracies surpassing that of the baseline. Table 1 also lists when the accuracy of the data series 1508, 1510, and 1512 surpassed that of the baseline.

TABLE 1
Accuracy of Demonstrations for First Target Variable

| | | Exceeded |
|---|---|---|
| Demonstration | Accuracy | Baseline After |
| Baseline: Prior-Art Incremental | 64.1% | N/A |
| Feature Selection (Data Series 1502) | | |
| Data Series 1504 (α = 1.15) | 63.6% | never |
| Data Series 1506 (α = 1.28) | 60.7% | never |
| Data Series 1508 (α = 1.44) | 65.2% | 7.8 hours |
| Data Series 1510 (α = 1.64) | 64.5% | 9.7 hours |
| Data Series 1512 (α = 1.96) | 66.2% | 25.6 hours |

Table 2 summarizes the results of a second set of demonstrations that are similar to those shown in FIG. 15 and Table 1, except that a different target variable was used. Here, the present embodiments outperformed the baseline for all values of α.

TABLE 2
Accuracy of Demonstrations for Second Target Variable

| | | Exceeded |
|---|---|---|
| Demonstration | Accuracy | Baseline After |
| Baseline: Prior-Art Incremental | 82.6% | N/A |
| Feature Selection | | |
| Swiss tournament with α = 1.15 | 83.4% | 2.2 hours |
| Swiss tournament with α = 1.28 | 83.8% | 4.7 hours |
| Swiss tournament with α = 1.44 | 82.8% | 4.3 hours |
| Swiss tournament with α = 1.64 | 83.1% | 7.5 hours |
| Swiss tournament with α = 1.96 | 82.9% | 11.54 hours |

The development of advanced forecasting models may be summarized with the following four stages:
(1) No Model—forecasting is based on data from previous months.
(2) Statistical Univariate Models—apply a statistical model, which learns from the target values in the past and extrapolates into the future.
(3) Multivariate Models—based on hypotheses, source and test external features, which could help improve the models.
(4) Large Volumes of Data—explore a huge amount of data to find more features, or better features, that improve the predictive accuracy of the model.
   The present embodiments address the transition from stage three to stage four. The above demonstrations compare the performance of the present embodiments to that of a state-of-the-art technique used for stage-four large-volume data exploration.

While the above demonstrations show that the present embodiments achieve only a one-percentage-point increase in predictive accuracy over the prior art, it should be recognized that for a business or product line in stage four, such an increase may generate several million dollars in profit. Accordingly, what may seem as a modest improvement can in fact have a substantial impact on business operations. For comparison, an increase of ten percentage points is typically considered the goal for stage-one, while an increase of one-to-three percentage points (and at most five percentage points) usually applies for stages two and three. It is expected that the present embodiments will show even greater increases in accuracy over the prior art when more than 90,000 candidate features are considered (e.g., several hundred thousand or million) as current state of the art processes are often unable to handle larger data sets due to the ballooning computation requirement that result from attempting to address larger data sets.

Combinations of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) A feature-selection method includes receiving a target feature and an initial bucket ranking of initial buckets that partition an initial candidate-feature ranking of candidate features. Each of the candidate features has an initial score. The candidate features of the initial candidate-feature ranking are ranked based on the initial score. The feature-selection method also includes, for each initial bucket of the initial bucket ranking, training a prediction model with (i) feature data associated with each candidate feature of the each initial bucket and (ii) target data associated with the target feature, and updating, with the prediction model, the initial score of the each candidate feature into an updated score. The feature-selection method also includes sorting, based on the updated score, the candidate features to create an updated candidate-feature ranking, and outputting one or more highest-ranked candidate features of the updated candidate-feature ranking.

(A2) In the feature-selection method denoted (A1), the feature-selection method may further include partitioning, based on the updated score, the updated candidate-feature ranking into an updated bucket ranking of updated buckets. The outputting may include outputting one or more highest-ranked updated buckets of the updated bucket ranking.

(A3) In the feature-selection method denoted (A2), the feature-selection method may further include iterating the training, updating, sorting, and partitioning over a plurality of iterations. The feature-selection method may further include using the updated bucket ranking created during one of the plurality of iterations as the initial bucket ranking for a succeeding one of the plurality of iterations. The outputting may include outputting one or more highest-ranked updated buckets of a last one of the plurality of iterations.

(A4) In the feature-selection method denoted (A3), the feature-selection method may further include calculating, based on the updated bucket ranking and initial bucket ranking, a convergence score. The iterating may be based on the convergence score.

(A5) In any one of the feature-selection methods denoted (A2) to (A4), the partitioning may include one-dimensional clustering.

(A6) In the feature-selection method denoted (A5), the one-dimensional clustering may include head-tail breaking the updated candidate-feature ranking into a head subset and a tail subset, the tail subset being one of the updated buckets.

(A7) In the feature-selection method denoted (A6), the feature-selection method may further include iteratively head-tail breaking the head subset into two or more of the updated buckets.

(A8) In either one of the feature-selection methods denoted (A6) and (A7), the head-tail breaking may include calculating an arithmetic mean of the updated scores, inserting, to the head subset, each candidate feature whose updated score is greater than the arithmetic mean, and inserting, to the tail subset, each candidate feature whose updated score is less than the arithmetic mean.

(A9) In any one of the feature-selection methods denoted (A2) to (A8), the feature-selection method may further include removing one or more lowest-ranked updated buckets of the updated bucket ranking to create a truncated bucket ranking.

(A10) In the feature-selection method denoted (A9), the feature-selection method may further include calculating, based on the initial bucket ranking and the updated bucket ranking, a rank correlation score. The removing may occur if the rank correlation score exceeds a threshold.

(A11) In either one of the feature-selection methods denoted (A9) and (A10), the feature-selection method may further include calculating, based on the initial bucket ranking and the updated bucket ranking, a rank correlation score, and adding the rank correlation score to a history of rank correlation scores. The removing may occur if a most-recent portion of the history exhibits a plateau.

(A12) In any one of the feature-selection methods denoted (A9) to (A11), the feature-selection method may further include repeating the training, updating, sorting, and partitioning with the truncated bucket ranking as the initial bucket ranking.

(A13) In any one of the feature-selection methods denoted (A1) to (A12), the feature-selection method may further include partitioning, based on the initial score, the initial candidate-feature ranking into the initial bucking ranking.

(A14) In the feature-selection method denoted (A13), the feature-selection method may further include iterating the partitioning, training, updating, and sorting over a plurality of iterations, and using the updated candidate-feature ranking created during one of the plurality of iterations as the initial candidate-feature ranking for a subsequent one of the plurality of iterations. The outputting may include outputting one or more highest-ranked candidate features of a last one of the plurality of iterations.

(A15) In the feature-selection method denoted (A14), the feature-selection method may further include calculating, based on the initial candidate-feature ranking and the updated candidate-feature ranking, a convergence score. The iterating may be based on the convergence score.

(A16) In the feature-selection method denoted (A14), a number of the plurality of iterations may be predetermined.

(A17) In any one of the feature-selection methods denoted (A13) to (A16), the feature-selection method may further include removing one or more lowest-ranked candidate features from the updated candidate-feature ranking to create a truncated candidate-feature ranking.

(A18) In the feature-selection method denoted (A17), the feature-selection method may further include calculating, based on the initial candidate-feature ranking and the updated candidate-feature ranking, a rank correlation. The removing may occur if the rank correlation score exceeds a threshold.

(A19) In either one of the feature-selection methods denoted (A17) and (A18), the feature-selection method may further include calculating, based on the initial candidate-feature ranking and the updated candidate-feature ranking, a rank correlation score, and adding the rank correlation score to a history of rank correlation scores. The removing occur if a most-recent portion of the history exhibits a plateau.

(A20) In any one of the feature-selection methods denoted (A17) to (A19), the feature-selection method may further include repeating the partitioning, training, updating, and sorting with the truncated candidate-feature ranking as the initial candidate-feature ranking.

(A21) In any one of the feature-selection methods denoted (A1) to (A20), the updating may include obtaining from the trained prediction model a first performance measure using test data associated with the each candidate feature, randomizing the test data to create randomized test data, and obtaining a second performance measure by running the trained prediction model with (i) the randomized test data, and (ii) test data associated with all other candidate features of the each initial bucket. The updating may also include comparing the first performance measure and the second performance measure to obtain a score update for the each candidate feature, and adding the score update to the initial score of the each candidate feature.

(A22) In the feature-selection method denoted (A21), the randomizing the test data may include permuting the test data.

(A23) In either one of the feature-selection methods denoted (A21) and (A22), the randomizing the test data may include adding randomly generated noise to the test data.

(A24) In any one of the feature-selection methods denoted (A21) to (A23), each of the first performance measure and the second performance measure may be a model prediction error.

(A25) In any one of the feature-selection methods denoted (A21) to (A24), the test data associated with the each candidate feature may be the same as the feature data associated with the each candidate feature.

(A26) In any one of the feature-selection methods denoted (A1) to (A25), all of the initial buckets may have the same number of candidate features.

(A27) In any one of the feature-selection methods denoted (A1) to (A25), all but a lowest-ranked one of the initial buckets may have the same number of candidate features, and the lowest-ranked one of the initial buckets has less than the same number.

(A28) In any one of the feature-selection methods denoted (A1) to (A27), the prediction model may be selected from the group consisting of: a linear regression model, a nonlinear regression model, a random forest, a Bayesian model, a support vector machine, and a neural network.

(A29) In any one of the feature-selection methods denoted (A1) to (A27), the prediction model may be a time-series model and the feature data associated with each candidate feature may be a time series.

(A30) In the feature-selection method denoted (A29), the feature-selection method may further include interpolating at least one time series such that all of the time series associated with the candidate features of the each initial subset are aligned in time.

(A31) In any one of the feature-selection methods denoted (A1) to (A30), the feature-selection method may further include creating the initial bucket ranking by selecting the candidate features, assigning a value to the initial score of each of the candidate features, sorting, based on the initial score, the candidate features to create the initial candidate-feature ranking, and partitioning the initial candidate-feature ranking into the initial buckets.

(A32) In any one of the feature-selection methods denoted (A1) to (A31), the feature-selection method may further include retrieving the feature data and the target data from a data repository.

(B1) A feature-selection system may include a processor and a memory in electronic communication with the processor. The memory may store a target feature and an initial bucket ranking of initial buckets that partition an initial candidate-feature ranking of candidate features. Each of the candidate features may have an initial score. The candidate features of the initial candidate-feature ranking may be ranked based on the initial score. The feature-selection system may also include a feature-ranking engine implemented as machine-readable instructions stored in the memory that, when executed by the processor, control the feature-selection system to, for each initial bucket of the initial bucket ranking, (i) train a prediction model with feature data associated with each candidate feature of the each initial bucket and target data associated with the target feature and (ii) update, with the prediction model, the initial score of the each candidate feature into an updated score. The feature-ranking engine may also control the feature-selection system to sort, based on the updated score, the candidate features to create an updated candidate-feature ranking, and output one or more highest-ranked candidate features of the updated candidate-feature ranking.

(B2) In the feature-selection system denoted (B1), the feature-ranking engine may include additional machine-readable instructions that, when executed by the processor, control the feature-selection system to partition, based on the updated score, the updated candidate-feature ranking into an updated bucket ranking of updated buckets, and output one or more highest-ranked updated buckets of the updated bucket ranking.

(B3) In the feature-selection system denoted (B2), the feature-ranking engine may include additional machine-readable instructions that, when executed by the processor, control the feature-selection system to (i) iterate the machine-readable instructions that train, update, sort, and partition over a plurality of iterations, (ii) use the updated bucket ranking created during one of the plurality of iterations as the initial bucket ranking for a succeeding one of the plurality of iterations, and (iii) output one or more highest-ranked updated buckets of a last one of the plurality of iterations.

(B4) In the feature-selection system denoted (B3), the feature-ranking engine may include additional machine-readable instructions that, when executed by the processor, control the feature-selection system to calculate, based on the updated bucket ranking and initial bucket ranking, a convergence score. The machine-readable instructions that, when executed by the processor, control the feature-selection system to iterate may include machine-readable instructions that, when executed by the processor, control the feature-selection system to iterate based on the convergence score.

(B5) In any one of the feature-selection methods denoted (B2) to (B4), the machine-readable instructions that, when executed by the processor, control the feature-selection system to partition may include machine-readable instructions that, when executed by the processor, control the feature-selection system to one-dimensional cluster the updated candidate-feature ranking.

(B6) In the feature-selection system denoted (B5), the machine-readable instructions that, when executed by the processor, control the feature-selection system to one-dimension cluster may include machine-readable instructions that, when executed by the processor, control the feature-selection system to head-tail break the updated candidate-feature ranking into a head subset and a tail subset, the tail subset being one of the updated buckets.

(B7) In the feature-selection system denoted (B6), the feature-ranking engine may include additional machine-readable instructions that, when executed by the processor, control the feature-selection system to iteratively head-tail break the head subset into two or more of the updated buckets.

(B8) In either one of the feature-selection systems denoted (B6) and (B7), the machine-readable instructions that, when executed by the processor, control the feature-selection system to head-tail break may include machine-readable instructions that, when executed by the processor, control the feature-selection system to calculate an arithmetic mean of the updated scores, insert, to the head subset, each candidate feature whose updated score is greater than the arithmetic mean, and insert, to the tail subset, each candidate feature whose updated score is less than the arithmetic mean.

(B9) In any one of the feature-selection systems denoted (B2) to (B8), the feature-ranking engine may include additional machine-readable instructions that, when executed by the processor, control the feature-selection system to remove one or more lowest-ranked updated buckets of the updated bucket ranking to create a truncated bucket ranking.

(B10) In the feature-selection system denoted (B9), the feature-ranking engine may include additional machine-readable instructions that, when executed by the processor, control the feature-selection system to (i) calculate, based on the initial bucket ranking and the updated bucket ranking, a rank correlation score, and (ii) execute the machine-readable instructions that remove if the rank correlation score exceeds a threshold.

(B11) In either one of the feature-selection systems denoted (B9) and (B10), the feature-ranking engine may include additional machine-readable instructions that, when executed by the processor, control the feature-selection system to (i) calculate, based on the initial bucket ranking and the updated bucket ranking, a rank correlation score, (ii) add the rank correlation score to a history of rank correlation scores, and (iii) execute the machine-readable instructions that remove if a most-recent portion of the history exhibits a plateau.

(B12) In any one of the feature-selection systems denoted (B9) to (B11), the feature-ranking engine may include additional machine-readable instructions that, when executed by the processor, control the feature-selection system to repeat the machine-readable instructions that train, update, sort, and partition with the truncated bucket ranking as the initial bucket ranking.

(B13) In any one of the feature-selection systems denoted (B1) to (B12), the feature-ranking engine may include additional machine-readable instructions that, when executed by the processor, control the feature-selection system to partition, based on the initial score, the initial candidate-feature ranking into the initial bucking ranking.

(B14) In the feature-selection system denoted (B13), the feature-ranking engine may include additional machine-readable instructions that, when executed by the processor, control the feature-selection system to (i) iterate the machine-readable instructions that partition, train, update, and sort over a plurality of iterations, (ii) use the updated candidate-feature ranking created during one of the plurality of iterations as the initial candidate-feature ranking for a subsequent one of the plurality of iterations, and (iii) output one or more highest-ranked candidate features of a last one of the plurality of iterations.

(B15) In the feature-selection system denoted (B14), the feature-ranking engine may include additional machine-readable instructions that, when executed by the processor, control the feature-selection system to calculate, based on the initial candidate-feature ranking and the updated candidate-feature ranking, a convergence score. The machine-readable instructions that, when executed by the processor, control the feature-selection system to iterate may include machine-readable instructions that, when executed by the processor, control the feature-selection system to iterate based on the convergence score.

(B16) In the feature-selection system denoted (B14), a number of the plurality of iterations may be predetermined.

(B17) In any one of the feature-selection systems denoted (B13) to (B16), the feature-ranking engine may include additional machine-readable instructions that, when executed by the processor, control the feature-selection system to remove one or more lowest-ranked candidate features from the updated candidate-feature ranking to create a truncated candidate-feature ranking.

(B18) In the feature-selection system denoted (B17), the feature-ranking engine may include additional machine-readable instructions that, when executed by the processor, control the feature-selection system to (i) calculate, based on the initial candidate-feature ranking and the updated candidate-feature ranking, a rank correlation score, and (ii) execute the machine-readable instructions that remove if the rank correlation score exceeds a threshold.

(B19) In either one of the feature-selection systems denoted (B17) and (B18), the feature-ranking engine may include additional machine-readable instructions that, when executed by the processor, control the feature-selection system to (i) calculate, based on the initial candidate-feature ranking and the updated candidate-feature ranking, a rank correlation score, (ii) add the rank correlation score to a history of rank correlation scores, and (iii) execute the machine-readable instructions that remove if a most-recent portion of the history exhibits a plateau.

(B20) In any one of the feature-selection systems denoted (B17) to (B19), the feature-ranking engine may include additional machine-readable instructions that, when executed by the processor, control the feature-selection system to repeat the machine-readable instructions that partition, train, update, and sort with the truncated candidate-feature ranking as the initial candidate-feature ranking.

(B21) In any one of the feature-selection systems denoted (B1) to (B20), the machine-readable instructions that, when executed by the processor, control the feature-selection system to update may include machine-readable instructions that, when executed by the processor, control the feature-selection system to (i) obtain from the trained prediction model a first performance measure using test data associated with the each candidate feature, (ii) randomize the test data to create randomized test data, (iii) obtain a second performance measure by running the trained prediction model with the randomized test data and test data associated with all other candidate features of the each initial bucket, (iv) compare the first performance measure and the second performance measure to obtain a score update for the each candidate feature, and (v) add the score update to the initial score of the each candidate feature.

(B22) In the feature-selection system denoted (B21), the machine-readable instructions that, when executed by the processor, control the feature-selection randomize the test data may include machine-readable instructions that, when executed by the processor, control the feature-selection system to permute the test data.

(B23) In either one of the feature-selection systems denoted (B21) and (B22), the machine-readable instructions that, when executed by the processor, control the feature-selection randomize the test data may include machine-readable instructions that, when executed by the processor, control the feature-selection system to add randomly generated noise to the test data.

(B24) In any one of the feature-selection systems denoted (B21) to (B23), each of the first performance measure and the second performance measure may be a model prediction error.

(B25) In any one of the feature-selection systems denoted (B21) to (B24), the test data associated with the each candidate feature may be the same as the feature data associated with the each candidate feature.

(B26) In any one of the feature-selection systems denoted (B1) to (B25), all of the initial buckets may have the same number of candidate features.

(B27) In any one of the feature-selection systems denoted (B1) to (B25), all but a lowest-ranked one of the initial buckets may have the same number of candidate features, and the lowest-ranked one of the initial buckets has less than the same number.

(B28) In any one of the feature-selection systems denoted (B1) to (B27), the prediction model may be selected from the group consisting of: a linear regression model, a nonlinear regression model, a random forest, a Bayesian model, a support vector machine, and a neural network.

(B29) In any one of the feature-selection systems denoted (B1) to (B27), the prediction model may be a time-series model and the feature data associated with each candidate feature is a time series.

(B30) In the feature-selection system denoted (B29), the feature-ranking engine may include additional machine-readable instructions that, when executed by the processor, control the feature-selection system to interpolate at least one time series such that all of the time series associated with the candidate features of the each initial subset are aligned in time.

(B31) In any one of the feature-selection systems denoted (B1) to (B30), the feature-ranking engine including additional machine-readable instructions that, when executed by the processor, control the feature-selection system to (i) select the candidate features, (ii) assign a value to the initial score of each of the candidate features, (iii) sort, based on the initial score, the candidate features to create the initial candidate-feature ranking, and (iv) partition the initial candidate-feature ranking into the initial buckets to create the initial bucket ranking.

(B32) In any one of the feature-selection systems denoted (B1) to (B31), the feature-ranking engine may include additional machine-readable instructions that, when executed by the processor, control the feature-selection system to retrieve the feature data and the target data from a data repository.

(B33) In the feature-selection system denoted (B32), the feature-selection system may further include the data repository.

(C1) A method for constructing a multivariate prediction model includes receiving a set of candidate features, a set of target features, and target-feature weights corresponding to the target features. Each of the candidate features and target features may include a time series. The method also includes, for each target feature of the set of target features, performing the feature-selection method denoted (A1) with the each target feature and the set of candidate features to generate (i) a single-target ranking of the candidate features and (ii) a final candidate score for each of the candidate features in the single-target ranking. The method also includes, for each candidate feature of the set of candidate features, calculating, based on the target-feature weights and the final candidate score of the each candidate feature in each single-target ranking, a combined score. The method further includes ranking, based on the combined score, the candidate features into a combined ranking, and selecting a plurality of top-ranked candidate features from the combined ranking. The method further includes, for each target of the plurality of targets, generating training data from the time series of the each target and the time series of each of the highest-ranking candidate features. The method further includes training the multivariate prediction model with the training data.

(C2) In the method denoted (C1), the method may further include using the multivariate prediction model, after the training, to generate a prediction for one or more of the target features.

(C3) In the method denoted (C1), the method may further include outputting the prediction.

(C4) In any one of the methods denoted (C1) to (C3), the method may further include outputting the multivariate prediction model.

(D1) A method for selecting predictive data includes organizing time-series data into a plurality of candidate features, determining a predictive value of each of the plurality of candidate features compared to an event, comparing the predictive value of one-half of the plurality of candidate features to approximately the rest of the plurality of candidate features on a one-candidate-feature-to-one-candidate-feature basis, creating a hierarchy of the plurality of candidate features based on the results of the comparing, comparing the predictive value of adjacent candidate features in the hierarchy, updating the hierarchy based on the comparing of the predictive value of adjacent candidate features, and selecting some of the plurality of candidate features for predicting the event based on the updated hierarchy.

(D2) In the method denoted (D1), the comparing of the predictive value of one-half of the plurality of candidate features includes associating a first value with a winner and a second value with a loser of each comparison.

(D3) In the method denoted (D2), the creating of the hierarchy includes ordering the plurality of candidate features based on the value associated with each of the plurality of candidate features.

(D4) In either one of the methods denoted (D2) and (D3), the comparing of the predictive value of adjacent candidate features includes incrementing the value associated with the winner of each comparison.

(D5) In the method denoted (D4), the method may further include repeating the comparing of the predictive value of adjacent candidate features in the updated hierarchy, wherein the repeating of the comparing includes incrementing the value of the winner to create a revised value associated with each of the plurality of candidate features being compared, and updating the hierarchy based on the revised values.

(D6) In the method denoted (D5), the method may further include truncating a portion of the plurality of candidate features that have a lower value associated therewith and again comparing the predictive value of adjacent candidate features.

(D7) In either one of the methods denoted (D5) and (D6), the selecting of the candidate features may include selecting candidate features that have the greatest value associated therewith.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A feature-selection method, comprising:
receiving a target feature and an initial bucket ranking of initial buckets that partition an initial candidate-feature ranking of candidate features, each of the candidate features having an initial score, the candidate features of the initial candidate-feature ranking being ranked based on the initial score;
for each initial bucket of the initial bucket ranking:
training a prediction model with (i) feature data associated with each candidate feature of the each initial bucket and (ii) target data associated with the target feature; and
updating, with the prediction model, the initial score of the each candidate feature into an updated score;
sorting, based on the updated score, the candidate features to create an updated candidate-feature ranking; and
outputting one or more highest-ranked candidate features of the updated candidate-feature ranking.

2. The feature-selection method of claim 1,
further comprising partitioning, based on the updated score, the updated candidate-feature ranking into an updated bucket ranking of updated buckets;
wherein the outputting includes outputting one or more highest-ranked updated buckets of the updated bucket ranking.

3. The feature-selection method of claim 2, further comprising:
iterating the training, updating, sorting, and partitioning over a plurality of iterations; and
using the updated bucket ranking created during one of the plurality of iterations as the initial bucket ranking for a succeeding one of the plurality of iterations;
wherein the outputting includes outputting one or more highest-ranked updated buckets of a last one of the plurality of iterations.

4. The feature-selection method of claim 3,
further comprising calculating, based on the updated bucket ranking and initial bucket ranking, a convergence score;
wherein the iterating is based on the convergence score.

5. The feature-selection method of claim 2, wherein the partitioning includes one-dimensional clustering.

6. The feature-selection method of claim 5, wherein the one-dimensional clustering includes head-tail breaking the updated candidate-feature ranking into a head subset and a tail subset, the tail subset being one of the updated buckets and iteratively head-tail breaking the head subset into two or more of the updated buckets.

7. (canceled)

8. The feature-selection method of claim 2, wherein the one-dimensional clustering includes head-tail breaking the updated candidate-feature ranking into a head subset and a tail subset, the tail subset being one of the updated buckets and wherein the head-tail breaking includes:
calculating an arithmetic mean of the updated scores;
inserting, to the head subset, each candidate feature whose updated score is greater than the arithmetic mean; and
inserting, to the tail subset, each candidate feature whose updated score is less than the arithmetic mean.

9. (canceled)

10. The feature-selection method of claim 2, further comprising:
removing one or more lowest-ranked updated buckets of the updated bucket ranking to create a truncated bucket ranking;
calculating, based on the initial bucket ranking and the updated bucket ranking, a rank correlation score;
wherein the removing occurs if the rank correlation score exceeds a threshold.

11. The feature-selection method of claim 2, further comprising:
removing one or more lowest-ranked updated buckets of the updated bucket ranking to create a truncated bucket ranking;
calculating, based on the initial bucket ranking and the updated bucket ranking, a rank correlation score; and
adding the rank correlation score to a history of rank correlation scores;
wherein the removing occurs if a most-recent portion of the history exhibits a plateau.

12-16. (canceled)

17. The feature-selection method of claim 1, further comprising partitioning, based on the initial score, the initial candidate-feature ranking into the initial bucking ranking, the feature-selection method further comprising removing one or more lowest-ranked candidate features from the updated candidate-feature ranking to create a truncated candidate-feature ranking, and calculating, based on the initial candidate-feature ranking and the updated candidate-feature ranking, a rank correlation score, wherein the removing occurs if the rank correlation score exceeds a threshold.

18. (canceled)

19. (canceled)

20. (canceled)

21. The feature-selection method of claim 1, wherein the updating includes:
obtaining from the trained prediction model a first performance measure using test data associated with the each candidate feature;
randomizing the test data to create randomized test data;
obtaining a second performance measure by running the trained prediction model with (i) the randomized test data, and (ii) test data associated with all other candidate features of the each initial bucket;
comparing the first performance measure and the second performance measure to obtain a score update for the each candidate feature; and
adding the score update to the initial score of the each candidate feature.

22-30. (canceled)

31. The feature-selection method of claim 1, further comprising creating the initial bucket ranking by:
selecting the candidate features;
assigning a value to the initial score of each of the candidate features;
sorting, based on the initial score, the candidate features to create the initial candidate-feature ranking; and
partitioning the initial candidate-feature ranking into the initial buckets.

32-65. (canceled)

66. A method for constructing a multivariate prediction model, comprising:
receiving a set of candidate features, a set of target features, and target-feature weights corresponding to the target features, each of the candidate features and target features comprising a time series;
for each target feature of the set of target features:
performing the feature-selection method of claim 1 with the each target feature and the set of candidate features to generate (i) a single-target ranking of the candidate features and (ii) a final candidate score for each of the candidate features in the single-target ranking; and
for each candidate feature of the set of candidate features:
calculating, based on the target-feature weights and the final candidate score of the each candidate feature in each single-target ranking, a combined score;
ranking, based on the combined score, the candidate features into a combined ranking;
selecting a plurality of top-ranked candidate features from the combined ranking;
for each target of the plurality of targets:
generating training data from the time series of the each target and the time series of each of the highest-ranking candidate features; and
training the multivariate prediction model with the training data.

67. The method of claim 66, further comprising using the multivariate prediction model, after the training, to generate a prediction for one or more of the target features.

68. The method of claim 67, further comprising outputting the prediction.

69. The method of claim 66, further comprising outputting the multivariate prediction model.

70. A method for selecting predictive data, comprising:
organizing time-series data into a plurality of candidate features;
determining a predictive value of each of the plurality of candidate features compared to an event;
comparing the predictive value of one-half of the plurality of candidate features to approximately the rest of the plurality of candidate features on a one-candidate-feature-to-one-candidate-feature basis;
creating a hierarchy of the plurality of candidate features based on the results of the comparing;
comparing the predictive value of adjacent candidate features in the hierarchy;
updating the hierarchy based on the comparing of the predictive value of adjacent candidate features; and
selecting some of the plurality of candidate features for predicting the event based on the updated hierarchy.

71. The method of claim 70, wherein the comparing of the predictive value of one-half of the plurality of candidate features includes associating a first value with a winner and a second value with a loser of each comparison.

72. The method of claim 71, wherein the creating of the hierarchy includes ordering the plurality of candidate features based on the value associated with each of the plurality of candidate features and the comparing of the predictive value of adjacent candidate features includes incrementing the value associated with the winner of each comparison.

73. (canceled)

74. The method of claim 72, further comprising repeating the comparing of the predictive value of adjacent candidate features in the updated hierarchy, wherein the repeating of the comparing includes incrementing the value of the winner to create a revised value associated with each of the plurality of candidate features being compared, and updating the hierarchy based on the revised values and truncating a portion of the plurality of candidate features that have a lower value associated therewith and again comparing the predictive value of adjacent candidate features.

75. (canceled)

76. (canceled)
